(19) United States
(12) Patent Application Publication
(10) Pub. No.: US 2001/0037212 A1
(43) Pub. Date: Nov. 1, 2001

(54) System and method for supporting businesses

(76) Inventors: Hiroki Motosuna, Tokyo (JP); Naoaki Kameyama, Tokyo (JP); Tomohiko Fujiyama, Tokyo (JP)

Correspondence Address: PAPPER HAMILTON LLP, 600 Fourteenth Street, N.W., Washington, DC, 20005-2004, US

(21) Appl. No.: 09/840,239

(22) Filed: Apr. 24, 2001

(30) Foreign Application Priority Data
Apr. 24, 2000 (JP) 2000-123067
Jan. 26, 2001 (JP) 2001-019297

(51) Int. Cl. G06F 17/60

(52) U.S. Cl. 705/1

(57) ABSTRACT

A business-supporting server supports a client. A request-obtaining unit obtains key request information showing requests of the client, who is provided with a business of the business-supporting organization. A business contents database has each of business contents information of a plurality of business functions. An adaptive function-selecting unit selects the business functions, which adapt to the requests of the client, by evaluating adaptability of the business contents information to the key request information based on the key request information and the business contents database. A function presentation-processing unit presents the information of the selected business functions to the clients. Therefore, functions of a business supporter such as a general trading company may be appropriately provided on the Web.

This patent application claims priority based on Japanese patent applications, No. 2000-123067 filed on Apr. 24, 2000 and No.2001-19297 filed on Jan. 26, 2001, the contents of which are incorporated herein by reference.

### BACKGROUND OF THE INVENTION

1. Field of the Invention

The present invention relates to a system, a method, a program, and a recording medium for supporting clients such as corporations, according to the clients' needs. This preferably applies to a system, which carries out the operation of organizational functions, such as a function of a general trading company on the Web.

2. Description of the Related Art

Usually, a company is composed of a congregation of plural business functions. Here, a case of a general trading company is described as an example of a company, which supports businesses for other companies. A general trading company has a plurality of business functions. Examples of business functions include trading goods, project management, commercialization business, money market, IT (Information Technology), administration, consulting, and management. The general trading company offers various functions to clients by taking advantage of its own knowledge.

With the recent spread of the Internet, we began to think of offering general-trading-company functions on the Web. If a general trading company could offer an appropriate function suited to clients' needs by selecting the appropriate function from a group of general-trading-company functions, both the general trading company and the clients might be greatly advantaged.

It could be thought to apply the existing company-introduction homepage for functioning as a general trading company on the Web. However, a mere homepage like this one cannot make the best use of distinctive features and makes it hard to offer high-quality services.

To describe further the point described above, it is better to give here a full account of functions of a typical general trading company. In each area/function of a general trading company, specific knowledge is accumulated. In the field of knowledge management, knowledge maybe divided into explicit knowledge, which is easy to define, and implicit knowledge, which is difficult to define. The latter is related to so-called know-how and skills and managed by persons in charge. One of the distinctive features of trade-company functions is to make the most use of this implicit knowledge by adapting it to clients' needs. It is not easy to make full use of this feature of general-trading-company functions, by applying a general company-introduction homepage, and as a result, it is not easy to appropriately correspond general-trading-company functions to the clients' needs.

Meanwhile, a system for searching a corresponding counterpart suited to the needs based on the others has already been proposed. It might be thought to use this type of system for providing general-trading-company functions. However, it is difficult to appropriately correspond general-trading-company functions to the clients by applying this existing search system.

The background of the present invention has been described by using a general trade company as an example. It is, however, not limited to general trading companies, and applies to other organizations or companies also. These organizations or companies providing business functions are called here as a business-supporting organization.

### SUMMARY OF THE INVENTION

Therefore, it is an object of the present invention to provide a system and a method for supporting clients, which overcomes the above issues in the related art. This object is achieved by combinations described in the independent claims. The dependent claims define further advantageous and exemplary combinations of the present invention.

(1)The aspect of the present invention is a business-supporting system that supports activities of a client. This system comprises a request-obtaining unit obtaining key request information which represents a request of a client who is provided with a service of the system; a business contents database including the business contents information of each of several business functions; and an adaptive function-selecting unit selecting a business function which adapts to the request of the client from a plurality of business functions, by evaluating the adaptability of the business contents information to the key request information, based on the key request information and the business contents database.

Preferably, the adaptive function-selecting unit may evaluate the adaptability based on a plurality of the key request information, which corresponds to the request of said client respectively.

Preferably, the key request information may include a question for eliciting the client's request, a keyword associated with the question, and character information input by the client, and the adaptive function-selecting unit may evaluate the adaptability based on at least two of: the business function previously corresponding to the question for eliciting the client's request respectively; the business function previously corresponding to the keyword associated with the question; and the business function retrieved based on the character information input by the client.

Preferably, the adaptive function-selecting unit may evaluate the adaptability by referring to each of: the business function corresponding to the question; the keyword corresponding to the question; and the business function retrieved based on the character information, with a predetermined degree.

According to the present invention, since the system evaluates the adaptability of the client's needs to the business contents information, an appropriate business function may be offered to the client. The business contents are preferably information including knowledge of the corresponding functions. As described later, business contents information is preferably composed of sentences describing matters related to business. By using sentences, the appropriate business contents information including knowledge of corresponding function may be available. Business contents information preferably includes an abstract of a business, business records, and an evaluation of records.

(2) Preferably, a request-obtaining unit may have a question-presenting unit for presenting several questions in order to discover a request of the client and find the key request information from the answers of the client to a plurality of questions. By using a questionnaire, the client's requests are comprehended appropriately.

Preferably, the request-obtaining unit may retrieve the key request information from the requested sentences obtained from the clients. Preferably, the request-obtaining unit may retrieve built-in-sentence key information included in the requested sentences and related key information related to built-in-sentence key information as the key request information.

(3) Preferably, an adaptive function-selecting unit may judge the adaptability of the business function based on the degree of relevance of each of several pieces of key request information and the business contents information. By combining the degree of relevance of several pieces of key request information, the adaptability of a business function may be judged appropriately.

Preferably, the business contents information in the business contents database may be composed of the aggregation of a plurality of the business contents element information. The adaptive function-selecting unit may calculate the adaptability of the key request information to the business contents information based on the degree of relevance of the key request information and the business contents element information.

Preferably, the business contents information in the business contents database may include the business contents sentences in which business contents are described. The strength of the relevance between the business contents sentences and the key request information may be calculated. The adaptive function-selecting unit may calculate the adaptability of the key request information to the business contents information based on the degree of relevance of each of several pieces of key request information and the sentence elements included in the business contents sentences. The sentence elements may correspond to the business contents element information and, preferably, the words included in the business contents sentences.

Preferably, for each of a plurality of the key request information, the sentence elements related to the key request information, which are words having more than a pre-determined level of relevance, may be searched from the group of sentence elements composing the business contents sentences, and the adaptability is calculated based on the result of searching. The business functions having more related sentence elements may be selected as the adaptive business function. The whole adaptability may be judged by statistically evaluating the degree of relevance related to the key request information.

(4) Preferably, the business contents information may include business records of the corresponding business function. The adaptive function-selecting unit may evaluate the adaptability of the key request information and the business contents information based on the business records. The business records may be written, for example, in the sentences of the business contents information. By considering the business records, the adaptability may be calculated more appropriately. Preferably, the business contents information may include the evaluation information showing the evaluation of degree of relevance for the business records, in addition to the business records. The adaptive function-selecting unit may evaluate the adaptability of the key request information to the business contents information depending on the evaluation information of the related business records when the related business records related to the key request information are included in the business contents information. By considering the evaluation of the business records, the adaptability may be appropriately calculated. The evaluation of the business records may be the evaluation obtained from the inside of a general trading company or the evaluation obtained from the outside of a general trading company. Preferably, both of the evaluations may be included. The evaluation obtained from the outside of a general trading company may be typically an evaluation of the client, who has received the offer of the corresponding function.

(5) Preferably, an adjustment-focused section based on the condition of the corresponding business function may be established. The adaptive function-selecting unit may adjust the adaptability when the key request information is related to the adjustment-focused section. The adaptability may be adjusted depending on the position of the related words in the business contents sentences. The adjustment-focused section may be the intensification focus section of the business function or may be the amelioration focus section of the business function, and when key request information is related to the intensification focus section and the amelioration focus section, the adaptability ma increase. Preferably, the number of business functions that may be designated as an intensification focus section may limit within a predetermined range. According to the present invention, the adaptability may be appropriately calculated according to the conditions such as the intensification and the amelioration of the business function.

Preferably, the adaptive function-selecting unit may adjust the adaptability by using a predetermined weighted index value for adjusting the adaptability. For example, the adaptive function-selecting unit may adjust the adaptability by using a different weighted index value according to the time when the business function is designated as an intensification focus section. The adaptive function-selecting unit may also adjust the adaptability by using a different weighted index value according to the time when the business contents information of the business function is ameliorated. The adaptive function-selecting unit may further adjust the adaptability by using a different weighted index value according to the time when the business contents information is registered to the business contents database. In these cases, the adaptive function-selecting unit may set the weighted index value higher when the time is newer.

Preferably, the adaptive function-selecting unit may adjust the adaptability by using a different weighted index value according to the number of the past offer records of the business function. In this case, the adaptive function-selecting unit may set the weighted index value higher when the number of the past offer records is larger.

Preferably, the adaptive function-selecting unit may adjust the adaptability by using a different weighted index value according to the degree of recency of the past offer records of the business function. In this case, the adaptive function-selecting unit may set the weighted index value higher when the past offer records is newer.

Preferably, the adaptive function-selecting unit may adjust the adaptability by using a different weighted index value according to the degree of an evaluation on the business function adapted to the selected client's request. In this case, the adaptive function-selecting unit may set the weighted index value higher when the evaluation is higher.

Preferably, the adaptive function-selecting unit may adjust the adaptability by using a different weighted index value according to the degree of recency of an evaluation on the business function adapted to the selected client's request. In this case, the adaptive function-selecting unit may set the weighted index value higher when the evaluation is newer.

Preferably, the adaptive function-selecting unit may adjust the adaptability by limiting the number of combining objects among: a different weighted index value according to the time when the business function is designated as an intensification focus section; a different weighted index value according to the time when the business contents information of the business function is ameliorated; a different weighted index value according to the number of the past offer records of the business function; a different weighted index value according to the time when the business contents information is registered to the business contents database; and a different weighted index value according to the degree of an evaluation on the business function adapted to the selected client's request.

Preferably, the adaptive function-selecting unit may alter at a predetermined degree at least one of the weighted index values among: a different weighted index value according to the time when the business function is designated as an intensification focus section; a different weighted index value according to the time when the business contents information of the business function is ameliorated; a different weighted index value according to the number of the past offer records of the business function; a different weighted index value according to the time when the business contents information is registered to the business contents database; and a different weighted index value according to the degree of an evaluation on the business function adapted to the selected client's request.

(6) Preferably, the business contents information may include a new business contents section intended to prepare for new business contents, as well as an existing business contents section for which existing business functions have already been prepared. The adaptability of the key request information to the business contents information may be judged differently depending on whether the key request information relates to the existing business contents section or the new business contents section. Preferably, a process may be adopted in which the adaptability increases more when the key request information relates to the new business content. In this way, the adaptability may be judged appropriately.

(7) Preferably, the business-supporting system of the present invention may include a database-updating-processing unit, or a rewriting-processing unit for updating or rewriting the business contents database. This updating-processing unit may update business contents information of the business contents database according to the business records when a new business record is made. The updating-processing unit may set an adjustment-focused section in the new business contents information, according to a request for setting the adjustment-focused section. Also, the updating-processing unit may set a new business contents section in the business contents information according to a request for setting the new business contents section. By using the updating-process like this one, the system may be maintained in the condition that the appropriate business functions may be offered to the clients.

Moreover, the database-updating-processing unit may re-modify the setting done by the updating or rewriting described above, by a process such as deletion and cancellation, according to the given condition. The given condition may mean preferably, after a certain period of time has elapsed since the updating, or matters that may be an object of request for updating. For example, the updating-processing unit may delete the business records, which are an object of a request, from the business contents information when a request for the deletion of the business record is made. A request for deletion may be made when a certain period of time has elapsed since the addition of a business record.

The updating-processing unit may take away the setting of the adjustment-focused section from the business contents information when a request for canceling the setting of the adjustment-focused section is made. A request for cancellation may be made when a certain period of time has elapsed since the setting of the adjustment-focused section.

The updating-processing unit may change the new business contents section into the existing business contents section when a request for canceling the setting of the new business contents section is made. A request for canceling the setting may be made when a certain period of time has elapsed since the setting.

(8) Preferably, before evaluating the adaptability of the key request information to the business contents information, an adaptive function candidate-selecting unit for finding from a plurality of business functions an adaptive function candidate, which is a candidate of business functions adapting to the key request information, may be established. The adaptive function-selecting unit may evaluate the adaptability of the adaptive function candidate to the key request information. Preferably, the adaptive function candidate-selecting unit may find the adaptive function candidate from the answers for the questions intended to establish the requests of the clients. Even though the adaptability of the key request information to the business contents is not evaluated, the business functions that have a high possibility of adapting to the key request information may be figured to a certain degree. Those kinds of business functions may be previously selected, and the adaptability may be evaluated as the selected function to be focused on. Through this process, the amount of data processing of the adaptability evaluation may be reduced considerably. It is useful for organizations or companies and especially for general trading companies composed of many functions.

Preferably, the adaptive function-selecting unit may select a business function, which has high adaptability with the key request information.

(9) Preferably, the system of the present invention may further include a presentation-processing unit for presenting the business functions offered to the clients by the business functions the adaptive function-selecting unit selected, for the clients. Preferably, the presentation-processing unit may present business functions having a high adaptability selected by the adaptive function-selecting unit. Preferably, the presentation-processing unit may present the business functions according to the priority order that may be obtained from the degree of adaptability calculated by the adaptive function-selecting unit According to the present invention, a plurality of functions suited to the requests of the client may be presented to the client comprehensively.

(10) Preferably, the system of the present invention may further include a perspective-obtaining unit for obtaining information of the perspective of the clients, showing the points of interest of each client. The presentation-processing unit may change the contents of presentation according to information on the perspective of the clients. It is possible to present information suited to the perspective of the clients.

Preferably, the perspective-obtaining unit may find information of the perspectives of the clients from the answers to questions intended to establish the requests of the clients. Preferably, a perspective judgment criterion-storing unit which stores the answers to the questions, the perspectives of the clients, and information on the perspective judgment criterion showing the intension of interest from the perspective. The client perspective-obtaining unit may seek information of the perspectives of the clients according to information of the perspective-judging criterion. Preferably, the presentation-processing unit may select the contents of the presentation which is presented to the clients, from the presentation contents candidates prepared for the adaptive function, which is selected by the adaptive function-selecting unit based on information of the perspectives of the clients.

According to the present invention, the questions for the clients may be used to find the perspectives of the clients as well as to obtain the key request information. For the clients, by just answering the questions, they may be provided with not only functions that meet their requests but also functions according to their perspectives. For the business supporter, by using the same questions, they may be provided not only with the requests of the clients but also the perspectives, and thereby the appropriate services may be provided.

(11) Preferably, the system of the present invention may further include a business presentation-processing unit for processing in order to provide the business functions after receiving a request for a business offer from the clients who has received the presentation of the business function. Preferably, the business presentation-processing unit may include a contact information-processing unit for telling the clients who in the business-supporting organization to contact with. Preferably, the business presentation-processing unit may include an explanation-presenting unit for presenting more detailed explanatory information of the presented business functions. According to the present invention, the operation of actually connecting the adaptive function to the clients may be carried out appropriately.

The present invention is not limited to the aspects of the system. The present invention may be achieved using the discrete aspects in the scope of the present invention. For example, other aspects of the present invention are: a business-supporting method; a program, which instructs a computer to execute processing procedures for supporting businesses; and a recording medium, which makes it possible to read a program from the computer in which the process for supporting businesses is recorded.

This summary of the invention does not necessarily describe all necessary features of the present invention. The present invention may also be a sub-combination of the features described above. The above and other features and advantages of the present invention will become more apparent from the following description of embodiments taken in conjunction with the accompanying drawings.

### BRIEF DESCRIPTION OF THE DRAWINGS

FIG. 1 is a diagram showing a system offering general-trading-company functions through communications according to the preferred embodiments.

FIG. 2 is a diagram showing a group of business functions of a business-supporting organization.

FIG. 3 is a diagram showing a business-supporting system that applies to the system described in FIG. 1.

FIG. 4 is a diagram showing the structure of a request-obtaining unit described in FIG. 3.

FIG. 5 is a diagram showing a questionnaire screen page, which is presented to clients.

FIG. 6 is a diagram showing a keyword table.

FIG. 7 is a diagram showing the information of the concept-requesting key.

FIG. 8 is a diagram showing a perspective-point table.

FIG. 9 is a diagram showing a candidate-selecting table.

FIG. 10 is a diagram showing the structure of an adaptive function-selecting unit.

FIG. 11 is a diagram showing business contents information.

FIG. 12 is a diagram showing an example of the business contents information.

FIG. 13 is a diagram showing an example of the business contents information.

FIG. 14 is a diagram showing the process that calculates the adaptability of the key request information to the business contents information.

FIG. 15 is a diagram showing the process that calculates the adaptability of the key request information to the business contents information.

FIG. 16 is a diagram showing another form of the adaptive function-selecting unit.

FIG. 17 is a diagram showing business contents information that is processed by an adaptive function-selecting unit.

FIG. 18 is a diagram showing another form of the adaptive function-selecting unit.

FIG. 19 is a diagram showing the business contents information being processed by the adaptive function-selecting unit described in FIG. 16.

FIG. 20 is a diagram showing the structure of a function presentation-processing unit.

FIG. 21 is a diagram showing an example of storage information in a presentation-retrieving-per-perspective unit.

FIG. 22 is a diagram showing an example of proposal-to clients screen pages.

FIG. 23 is a diagram showing the structure of a business operation-processing unit.

FIG. 24 is a diagram showing a screen page that communicates with clients.

FIG. 25 is a diagram showing a screen page that describes the details of functions.

FIG. 26 is a diagram showing a screen page that communicates with clients.

FIG. 27 is a diagram showing a flowchart that indicates an updating of the process of a business contents database.

FIG. 28 is a diagram showing a flowchart that indicates the process of canceling updated contents being done by the process described in FIG. 25.

FIG. 29 is a diagram showing an example of the top-page offered on the Web.

FIG. 30 is a diagram showing an example of a screen page for selecting functions.

FIG. 31 is a diagram showing a flowchart indicating an operational abstract of a business-supporting server in preferred embodiments.

FIG. 32 is a diagram showing a flowchart that indicates an operational abstract of the whole system in the present embodiments.

FIG. 33 is a diagram showing another embodiment of the business-supporting system.

FIG. 34 is a structural diagram showing a weighted search and a condition correspondence weight according to another embodiment.

FIG. 35 is an exemplary diagram showing a method of the weighted search.

FIG. 36 is an exemplary diagram showing a method of the condition correspondence weight, which makes the recency, intensification, and the improvement an object respectively.

FIG. 37 is an exemplary diagram showing a method of the condition correspondence weight, which makes the past performance records and an evaluation an object respectively.

FIG. 38 is an exemplary diagram showing a method for selecting business functions to present to clients based on the weighted search and the condition correspondence weight.

FIG. 39 is an exemplary diagram showing a method for adjusting adaptability by adding a priority degree of each element relating to the condition correspondence weight.

FIG. 40 is a diagram showing another embodiment of the business-supporting server.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

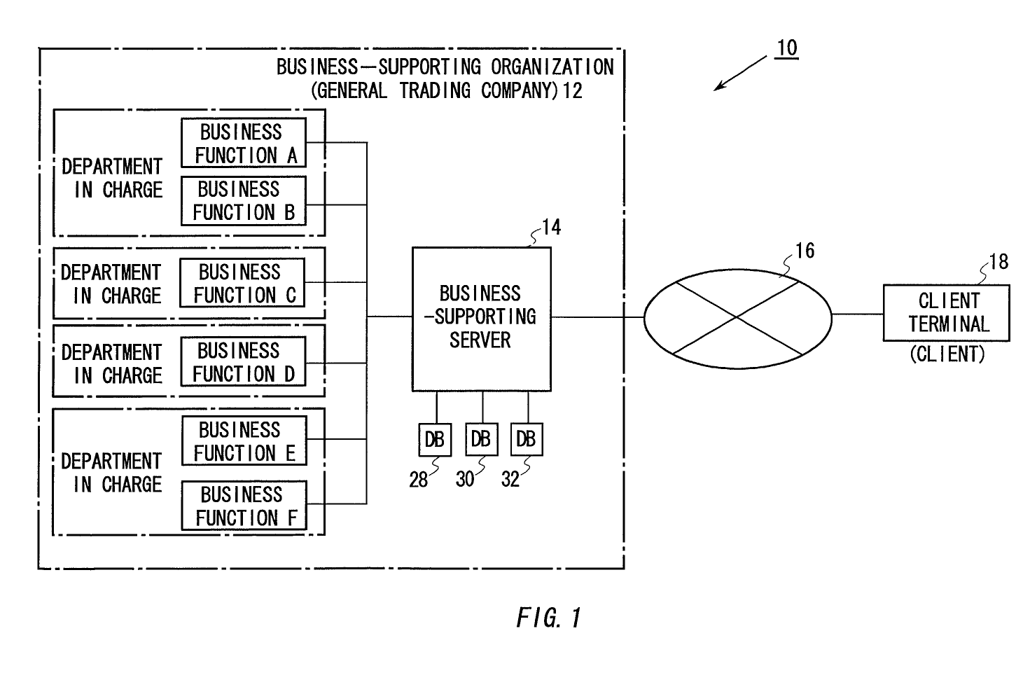

FIG. 1 is a diagram showing a system 10, which offers general-trading-company functions on the Web. According to the preferred embodiments, the present invention is applied to a general trading company, which is one form of business-supporting organizations. A business-supporting system of the invention is applied to the system 10 in FIG. 1. However, it is obvious that this invention may apply not only to general trading companies but also to other organizations. For example, the invention may be applied to organizations such as consulting firms, advertisement agencies, and such financial institutions as banks and securities companies.

In FIG. 1, the system 10 that applies to a business-supporting organization of a general trading company, has a plurality of business functions from A to F. Each business function belongs to a department in charge. Although six business functions are shown as an example in FIG. 1, there could be more business functions than these six.

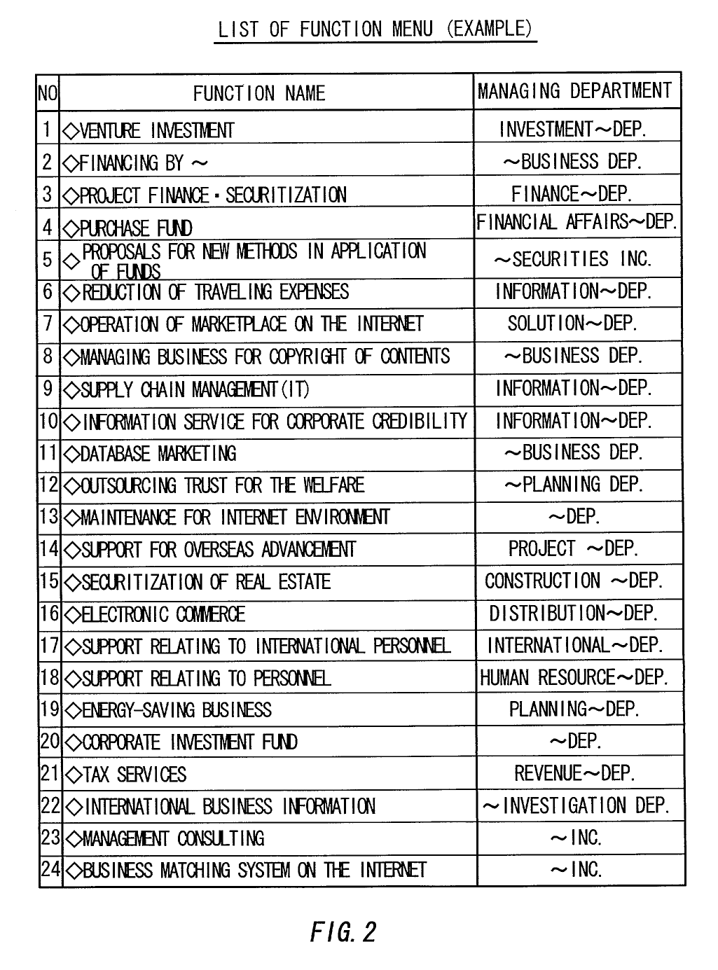

FIG. 2 is a diagram showing a table indicating a list of business functions. However, only a part of the entire general-trading-company functions are shown in FIG. 2. Also, the system 10 does not have to support all of the business functions. Moreover, the unit of a business function may be determined freely such that one of the business functions maybe an affiliated company made by a general trading company, for example, to carry out one function. Incidentally, as shown in FIG. 2, a general trading company has various business functions that are not limited to the conventional functions.

A plurality of the business functions shown in FIG. 1 is connected to the business-supporting server 14 for communication. As an example of communication tools, there are LAN and WAN. The business-supporting server 14 will be connected to the client terminal 18 through the Internet 16. Clients who want to use a service of a general trading company will access the business-supporting sever 14. The business-supporting server 14 responds to the access made by a client and provides various pieces of information, which is related to the general-trading-company functions, on the browser screen of the client terminal 18.

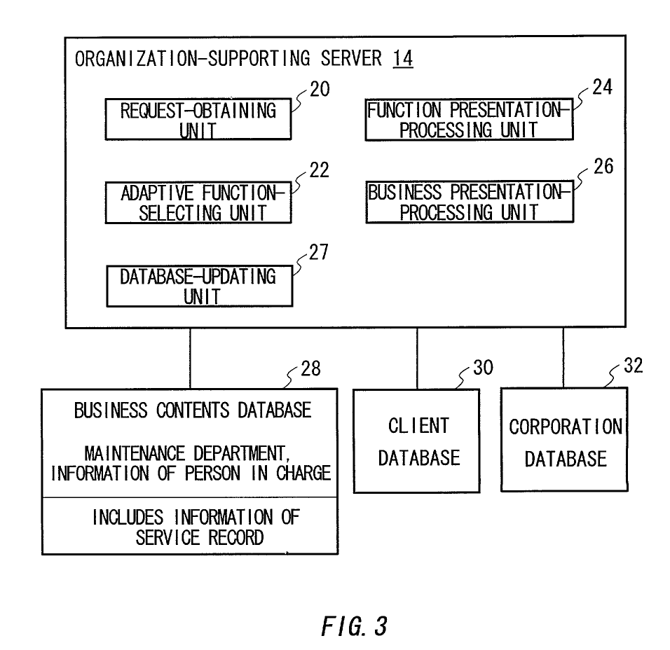

FIG. 3 is a diagram showing a structure of the business-supporting server 14. The business-supporting server 14 has a request-obtaining unit 20, an adaptive function-selecting unit 22, a function presentation-processing unit 24, a business presentation-processing unit 26, and a database-updating unit 27. The business-supporting server 14 is connected to a business contents database 28, a client database 30, and a corporation database 32. The business contents database 28 includes business contents information for each business function. The client database 30 has a record of the past clients and a performance record of business operations provided to each client. The corporation database 32 is used for managing the identity confirmation of the corporation.

The request-obtaining unit 20 obtains key request information, which shows client's needs, by communicating with the client terminal 18. The adaptive function-selecting unit 22 selects functions, which are adapted to client's needs, from a plurality of business functions based on the obtained key request information. By evaluating adaptability of the business contents information to key request information, a business function suited to client's needs, which is an adapted function, may be selected. The function presentation-processing unit 24 presents the selected adapted functions on the client terminal 18 as business functions that should be provided to clients. The business presentation-processing unit 26 performs a process for actually providing business functions, which are presented on the virtual system according to the client's needs. The database-updating unit 27 updates the business contents database 28 according to various needs. Now, each structure will be described in detail in the following.

### The Request-Obtaining Unit

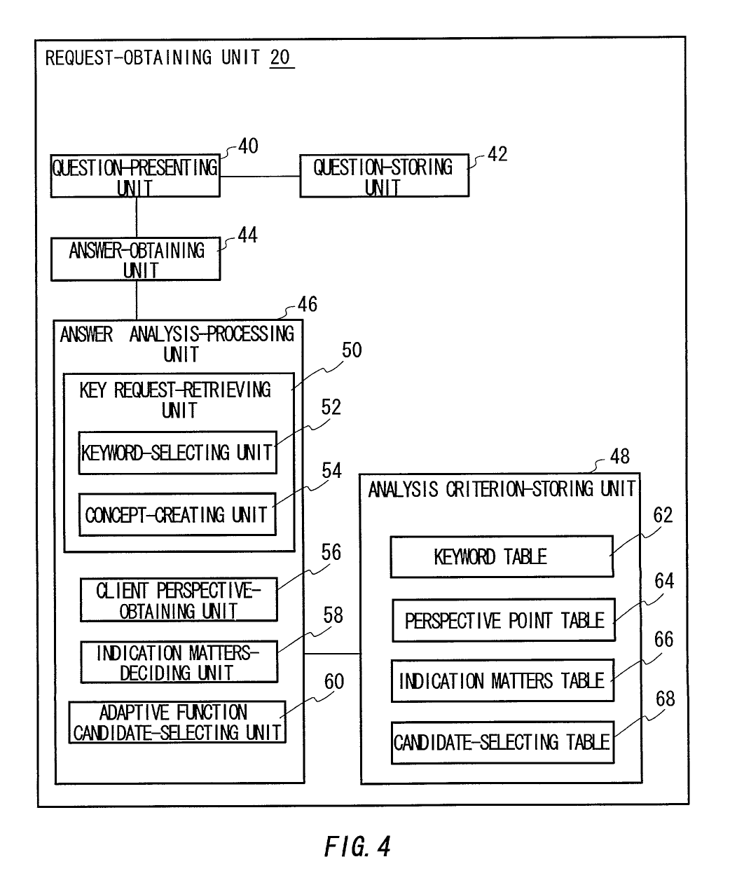

FIG. 4 is a diagram showing a structure of the request-obtaining unit 20. The request-obtaining unit 20 presents questions to clients and comprehends clients' requests by analyzing the answers. Simultaneously, clients perspectives, that is, the points in which each client is interested, will be obtained from the clients' answers.

The request-obtaining unit 20 has a question-presenting unit 40, a question-storing unit 42, an answer-obtaining unit 44, an answer analysis-processing unit 46, and an analysis criterion-storing unit 48. The question-storing unit 42 stores questions, which are to be presented to the clients. The question-presenting unit 40 sends the questions retrieved from the question-storing unit 42 to the client terminals 18.

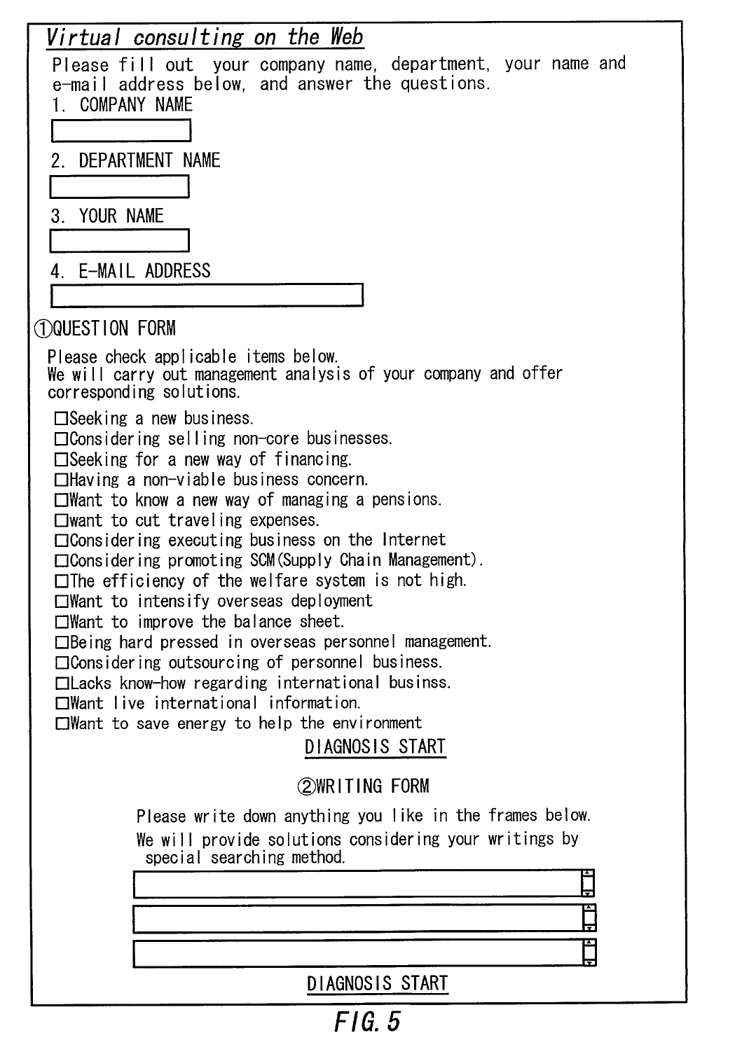

FIG. 5 is a diagram showing an example of a questionnaire screen page shown on the browser screen of the client terminals 18. A questionnaire page includes the survey questions to be clicked, shown in the middle of the figure, and a writing-type entry portion shown in the upper and the lower part of the figure.

A plurality of questions, which is an example of elements of the key request information, is prepared in the survey that have been previously set to properly derive clients' needs. There are seventeen questions related to managerial improvements as shown in the example of FIG. 5. A client operates the client terminal 18 and clicks the item that attracts the client's interest. Generally, the client clicks several items, such as five items for example. It is preferable that the questions are designed so that the number of items to be clicked is a reasonable number. The possible number of times to click may also be limited. On the other hand, in the writing-type entry portion at the lower part of the figure, a client writes down in a free form the client's problems related to the management (character information), and the point which the client wants improved related to the management, which cannot be represented fully by the listed questions.

Back to FIG. 4, the answer-obtaining unit 44 obtains answers that are the results of client's entries in the questionnaire page. The answer analysis-processing unit 46 analyzes the client's answers. The analysis criterions that are stored in the analysis criterion-storing unit 48 are used for the analyzing process.

The answer analysis-processing unit 46 has a key request-retrieving unit 50 that seeks the key request information, which represents clients needs. The key request-retrieving unit 50 has a keyword-selecting unit 52 and a concept-creating unit 54. The keyword-selecting unit 52 analyzes the answers of the survey questions shown in FIG. 5. The keyword table 62 of the analysis criterion-storing unit 48 is used for the analysis of the keyword-selecting unit 52.

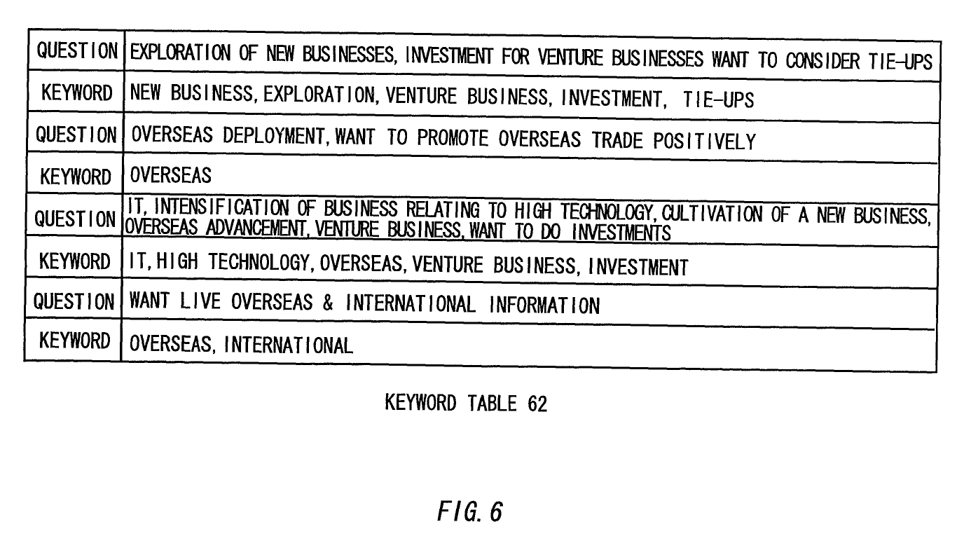

FIG. 6 is a diagram showing an example of the keyword table 62. A plurality of keywords is previously prepared as an example of elements of the key request information corresponding to each question item. According to the present embodiment, the keyword is a word in the sentences provided in the questionnaire. It is obviously possible to prepare words that are not included in the questionnaire in the key word table 62. The key word-selecting unit 52 reads the keywords, which are related to the items clicked by the client, from the keyword table 62. In this way, it is possible to retrieve keywords automatically, based on the items checked by clients.

On the other hand, the concept-creating unit 54 analyzes statements written in the writing-type entry portion shown in the lower part of FIG. 5. The concept-creating unit 54 retrieves the clients' needs from the text written by the clients, which is an example of elements of the key request information. Here, the concepts of clients' needs may be obtained from the client's text, without being limited to the range of the client's text. Therefore, the clients' needs may be properly understood regardless of the expression of the client's text.

More specifically, the concept-creating unit 54 retrieves words, or built-in words, included in the text. The words related to the built-in words that have been retrieved are taken out as related words. For example, by using a dictionary criterion that determines the degree of relevance between words, the words having higher levels of relevance than a pre-determined level are selected. Built-in words and related words are one form of the built-in key information and the related key information of the present invention and used as the key request information. The aggregation of the built-in words and related words are used as the concepts of clients' needs, in other words, used as groups of factors to define the client's concepts. The built-in words and related words are called concept key words in the following. The concept keywords may be processed as the keywords, which are selected by the keyword-selecting unit 52 described above.

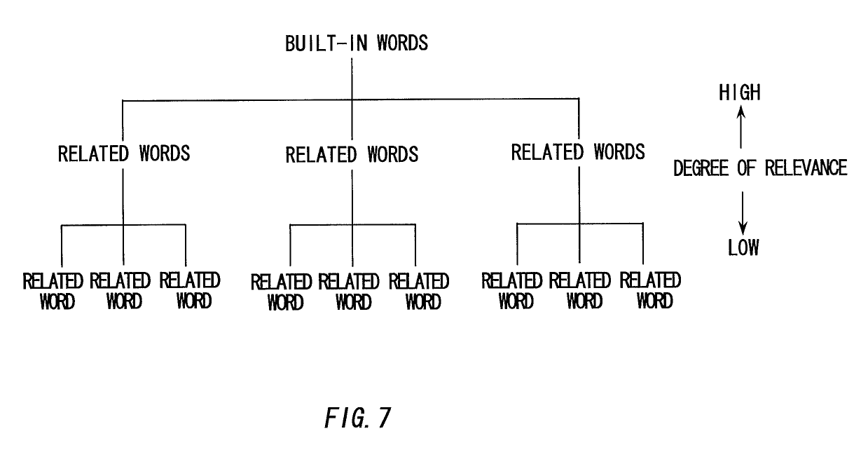

FIG. 7 is a diagram showing an example of a part of the retrieved concepts. Here, a built-in word selected from a client's text is shown. A plurality of related words is related to the built-in words. A plurality of related words is further related to each of the related words. The further the words are from the built-in words, the lower the degree of relevance becomes. Based on the degree of relevance between the previously defined words, the aggregation of words that have a higher degree of relevance than a pre-determined level may be obtained as a concept.

The above process is an information process that has a related word-retrieving function and a resemblance-searching function based on sentences. By using this function, related words may be obtained by calculating the degree of relevance, and the aggregation of the related words is retrieved as a concept.

Returning to FIG. 4, the answer analysis-processing unit 46 also includes a client perspective-obtaining unit 56. The client perspective-obtaining unit 56 obtains a clients perspective based on the result of the clients responses to the survey questions, as shown in FIG. 5. The client perspective is perspective information of the offered, which shows interested points of each client (the offered), such as from what perspective the client checks the item in answer to the question and from what perspective the client works. A perspective point table 64 provided in the analysis criterion-storing unit 48 is used for this client perspective obtaining process. The analysis criterion-storing unit 48 corresponds to the perspective judgment criterion-storing unit of the present invention.

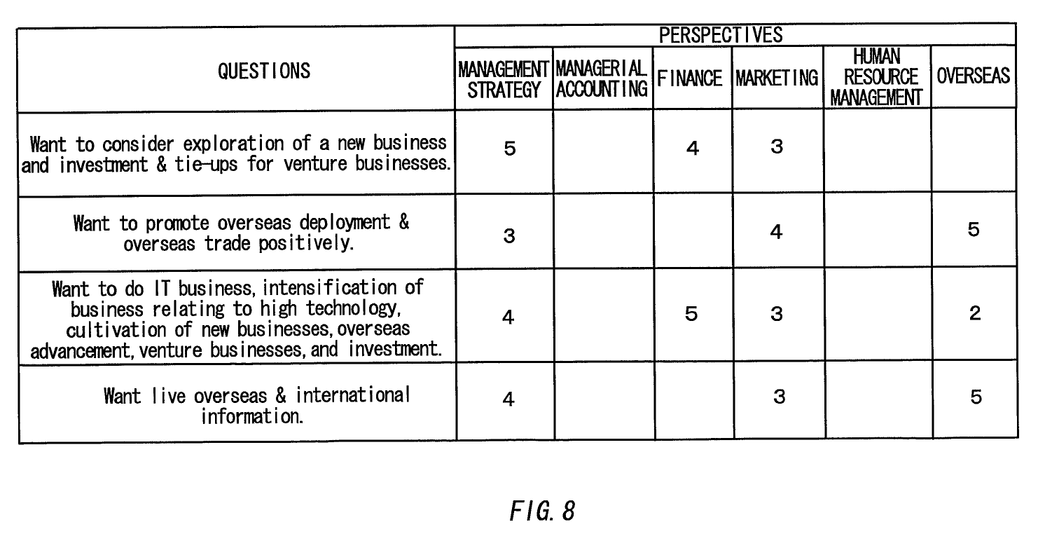

FIG. 8 is a diagram showing an example of a perspective point table 64. By corresponding to each question item for eliciting clients' needs, pluralities of perspectives correspond to each point of the question items. Perspectives include a management strategic perspective, a management accounting perspective, a financial perspective, a marketing perspective, a human resource management perspective, and an overseas perspective as examples. The point given to each perspective is an example of perspective judgment criteria information, which represents the general strength, or relationship in size, of interests to each perspective for clients who checked the corresponding questions.

The client perspective-obtaining unit 56 refers to the perspective point table 64 and obtains all points corresponding to the question items that are checked by the clients. The client perspective-obtaining unit 56 then calculates the sum of the points for each perspective. The perspective that has the biggest total points is determined as a client's perspective. In this way, the clients perspectives may be retrieved as well as keywords based on the items checked by the clients.

For example, in FIG. 8, there are five points for the management strategic perspective, four points for the financial perspective, and three points for the marketing perspective for the question “new business . . .” A plurality of perspective points may be obtained from all of the checked items. The sum of the points is calculated for each perspective. For example, it is assumed that the management strategic perspective had thirteen points, the marketing perspective had nine points, the overseas perspective had twelve points, and the financial perspective had nine points, as a result of counting. In this case, the client's perspective maybe determined as the management strategic perspective.

Here, a client's perspective may also be obtained by a process that differs from the present embodiment; for example, special questions may be used for obtaining a perspective. Also, the section for writing the perspectives may be provided to the questionnaire page. The clients input their perspectives in the perspective writing-type entry portion using a text format on the terminal screens.

Returning to FIG. 4, the answer analysis-processing unit 46 also has an indication matters-deciding unit 58. The indication matters-deciding unit 58 decides matters that should be indicated to the clients from the results of clients' answers. The indication matters are decided by using the indication matters table 66 in the analysis criterion-storing unit 48. The indication matters correspond to the combinations of question items by the indication matters table 66. Pluralities of indication matters are prepared together with the priority order for each combination. The indication matters, which correspond to the combinations of the question items checked by the clients, are read from the indication matters table 66.

Moreover, the answer analysis-processing unit 46 has an adaptive function candidate-selecting unit 60. The adaptive function candidate-selecting unit 60 finds candidates for the business functions, which are suited to the clients' needs (specifically, key request information), as adaptive function candidates from the group of functions according to the present system. As described above, a general trading company has various kinds of functions. However, the business functions, which are adapted to the items checked by the clients on the questionnaire page, are limited in some degree. Therefore, business functions that have high possibilities of being adaptive functions are previously selected. At the time of evaluating the adaptabilities, which will be described later, the business contents information of the adaptive functional candidates is processed. That is, the adaptive function-selecting unit 22 shown in FIG. 3 evaluates the adaptability of clients' key request information to the business contents information by limiting the evaluation to the adaptive functional candidates. By this kind of pre-process for finding the adaptive candidates, the amount of processing for evaluating the adaptability, which will be described later, may be greatly reduced.

The candidate-selecting table 68 of the analysis criterion-storing unit 48 is used for selecting the adaptive function candidate-selecting unit 60.

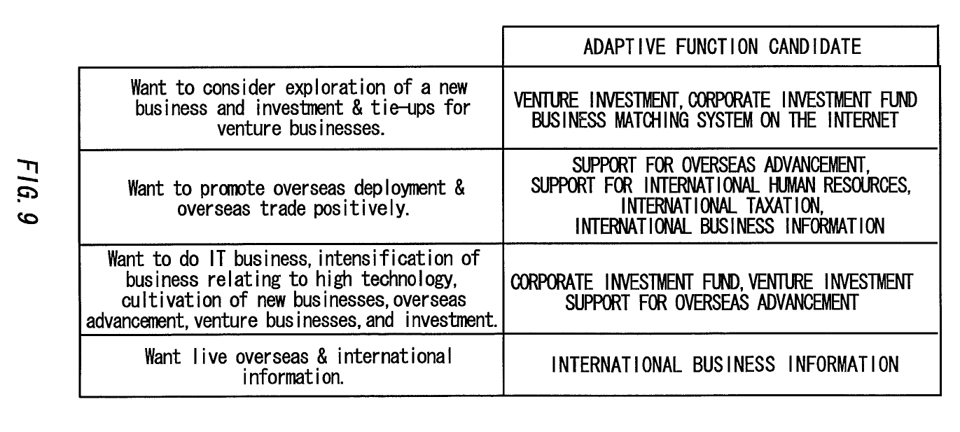

FIG. 9 is a diagram showing an example of a candidate-selecting table 68. The business functions, which are to be candidates, are previously associated with each of the question items for eliciting clients' needs. A plurality of business functions, two or three for example, are related to one question item. From the perspective of business functions, a business function is related to a plurality of question items. The adaptive function candidate-selecting unit 60 finds all of the business functions associated with all question items checked by the clients (clients' answers to the questions), from the candidate-selecting unit 68. These business functions are set as the adaptive function candidates.

The request-obtaining unit was described above. According to the present embodiment, the key request information of a client is automatically and appropriately obtained by utilizing a plurality of questions.

The key request information is automatically and appropriately obtained by analyzing the sentences written by the client. Especially, the client' s needs may be comprehended appropriately by retrieving the related key information as well as the key information that is directly included in the requesting sentences, using a natural word matching technique. Regardless of the suitability of expressions made by the clients, the clients' needs may be accurately assessed.

Moreover, according to the present embodiment, a client's perspective may be obtained by asking the questions to the client. This client perspective is suitably used for a business-supporting organization to propose a business to a client, which will be described below. The client's perspective is automatically obtained from the questions. The contents of a proposal may thereby be improved using the client's perspective.

Especially, the present embodiment has a merit in which a client's perspective may also be obtained from the questions, which are asked when obtaining the key request information. The clients may receive not only the proposals that satisfy the clients' needs, but also proposals of the functions adapted to the clients' perspectives, by simply answering the questions. Also, the business-supporting organizations may retrieve not only the requests from clients but also the perspectives of the clients using the common questions, and thereby the business-supporting organizations may provide the appropriate services.

Furthermore, according to the present embodiment, the adaptive function-candidates are obtained from the group of business functions of the present system. This process is performed as a pre-process of the adaptive function-selecting process performed in the next unit. By reducing the number of business functions to some degree, the amount of work for evaluating the adaptability may be greatly reduced. The amount of data to be processed for evaluating the adaptability may also be greatly reduced. The present embodiment is especially useful for organizations such as general trading companies that are composed of many functions.

### The Adaptive Function-selecting Unit

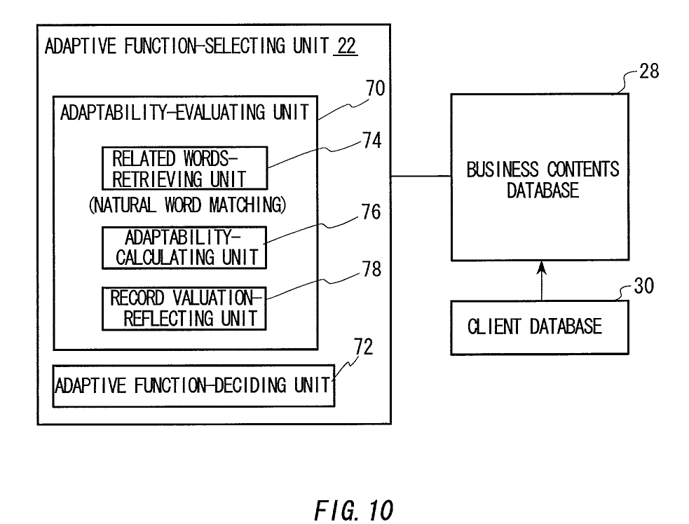

FIG. 10 is a diagram showing the structure of the adaptive function-selecting unit 22. The adaptive function-selecting unit 22 includes an adaptability-evaluating unit 70 and an adaptive function-deciding unit 72. The adaptability-evaluating unit 70 has a search engine function and includes a related words-retrieving unit 74, an adaptability-calculating unit 76, and a record valuation-reflecting unit 78.

The adaptive function-selecting unit 22 selects business functions that satisfy the needs of the client (the offered), by evaluating the adaptability of the business contents information to the key request information using key request information and business contents information. The key request information is obtained by the request-obtaining unit 20, as described above. According to the present embodiment, the key request information is such as: the question item itself for eliciting clients' needs, which is checked by the clients; the key words related to the question items checked by the clients; and the concept keywords that are retrieved based on the sentences (character information) written by the clients. Therefore, business functions that correspond to key request information are such as: business functions that correspond to question items checked by the clients; business functions that correspond to keywords; and business functions that correspond to concept keywords. It is preferable that the adaptive function-selecting unit 22 evaluates the adaptability based on at least two of these three business functions. On the other hand, the business contents information is stored in the business contents database 28.

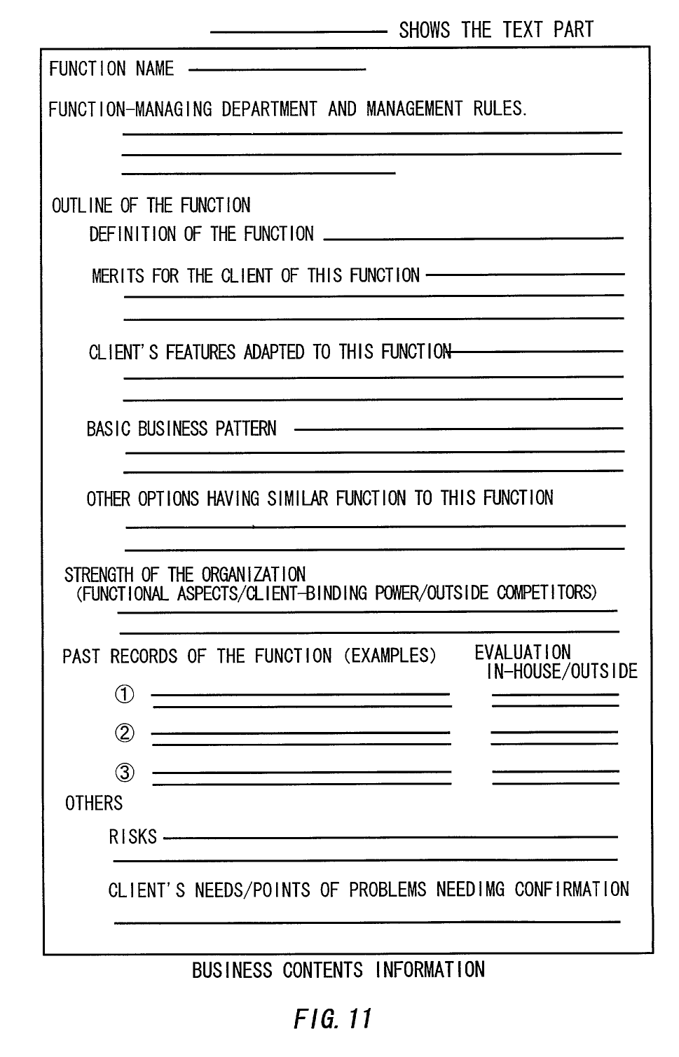

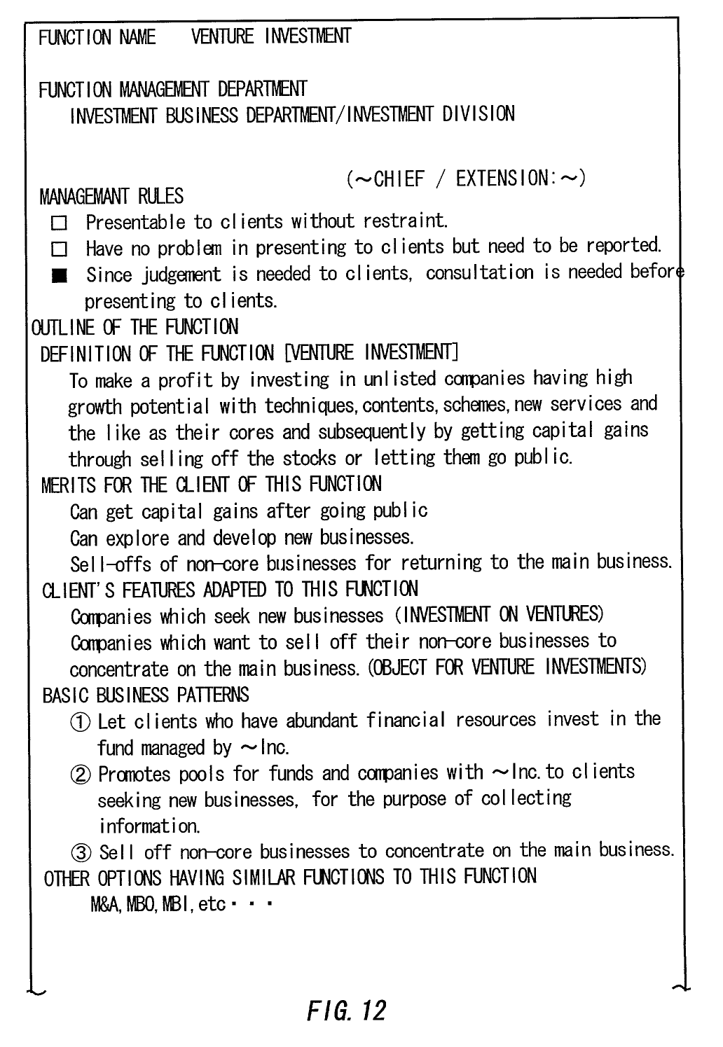

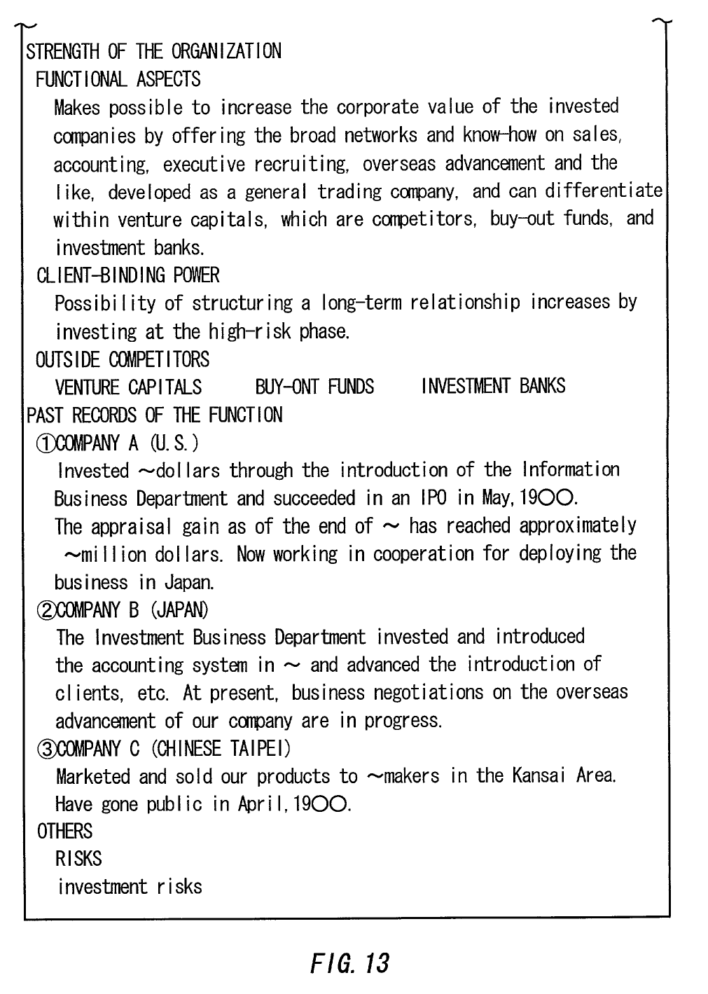

FIGS. 11 to 13 are diagrams showing the business contents information according to the present embodiment. FIG. 11 shows the business contents information in general. The writing-type entry portions (text portions) are represented by cross lines. FIGS. 12 and 13 show an example of the business contents information when the business function is a venture capital.

As described in FIGS. 11 to 13, the business contents information is composed of a text describing the business functions (text of business contents). The business contents information is written by the person in charge of the business function. The person in charge may create the business contents information by registering and updating the business contents on the Web through a communication means of course, the business contents information may be written by someone such as the operator of the system instead of the person in charge.

The business contents information includes a plurality of description items, that is “the function management department and the management rules”, “the abstract of the functions”, “the strength of this organization”, and “the past record of functions” and so on. “The function management department and the management rules” include the information of the function retention department and the person in charge of functions. “The past record of the functions” includes the contents of proposals, which were actually provided to clients in the past, and information of the results obtained by the proposals. However, the items described above are just some examples. Also, in the scope of the present invention, classification of the items shown above is not required. One or a plurality of the above items or other items may be actually included in the writings. Moreover, the business contents information may include related images or PDF files.

According to the present embodiment, “the past record of functions” is composed of specific cases from the past. This information of the past records that shows “the past record of functions” is obtained from the client database 30. The client database 30 stores the contents of proposals that were actually presented to each client in the past and the information of the business functions that were dealt with in the proposals. The past cases for each function (business records) are retrieved from this database 30.

The business contents information further includes the information showing the magnitude of the evaluation against “the past record of the functions” (the evaluation information). The evaluation information includes the in-house evaluation and the outside evaluation. The in-house evaluation is a self-evaluation of the main department of functions and is given to each case of business achievement based on profitability, speed, degree of client satisfaction and expansiveness. The outside evaluation is evaluated by a standard outside the business-supporting organization and is also given to each case of business achievement. The evaluation information may be obtained from the business contents database 30. The evaluation of the objected clients is previously included, in the information of the proposal contents of the past of the business contents database 30. This evaluation information is given to the corresponding business records of the business contents database 28.

Moreover, the business contents information described above has a text format and is composed of many words and phrases. Each word and phrase is an element that represents the business contents. Each word and phrase corresponds to one form of the business contents element of the present invention. That is, the business contents information is composed of the aggregation of a plurality of business contents elements, or the aggregation of the words and phrases.

Next, the process of evaluating the adaptability of the business functions and selecting the adaptive functions will be described using the business contents information described above.

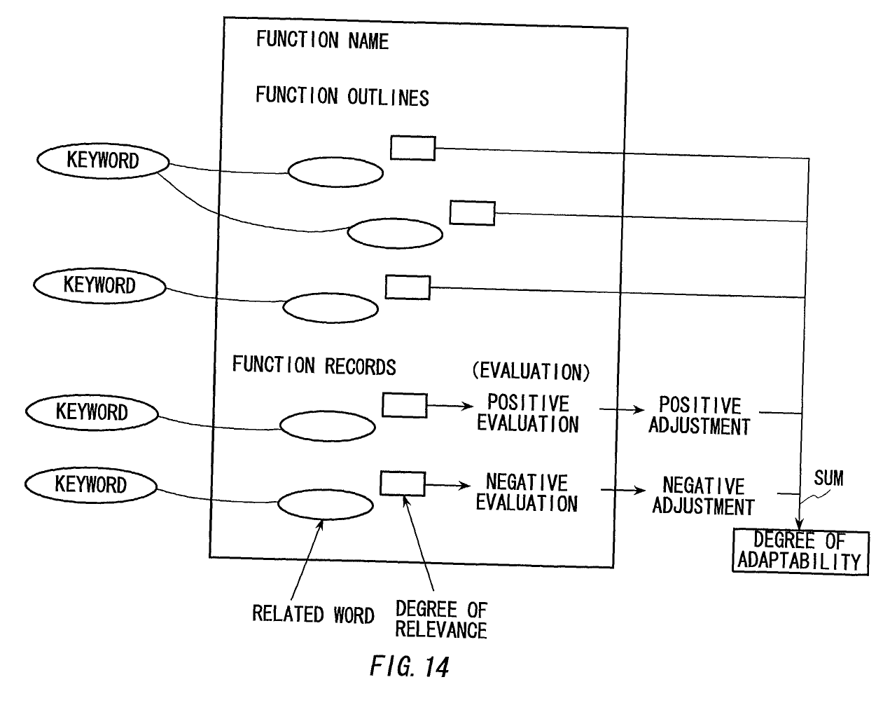

FIG. 14 shows the process of evaluating the adaptability. The business contents information is information on the business functions selected in the adaptive function candidate-selecting unit 60. Information to be input are keywords and concept keywords, which were obtained by the request-obtaining unit 20, and these keywords and concept key words may be processed alike. Contribution on the adaptability to the keywords and the concept keywords may be differentiated. For example, the degree of relevance, which may be obtained from the keywords and the concept keywords, may be given weights as in the process described later. Only keywords are shown in FIG. 14.

In FIG. 14, the related words-retrieving unit 74 retrieves words relating to keywords (sentence elements) from the business contents information. Here, the search engine searches through a business contents database 28 based on keywords. The degree of relevance between each word in the business contents information and keyword is calculated. A dictionary-based criterion, which has set up the degree of relevance between words, is used for the calculation of the relevance ratio, for example. The words, which have more than a pre-determined level of relevance, are decided as the related words (sentence elements relating to keywords). A plurality of related words may be selected for one keyword as described in FIG. 14. Otherwise, when a plurality of related words exists, only the word having the highest degree of relevance may be selected.

A record valuation-reflecting unit 78 undertakes the process described below to reflect the evaluation information, which is included with the past business records in the business contents information, on the adaptability. This process will be performed by evaluating the adaptability of the key request information to the business contents information according to the evaluation information of the past records of the related business when the past records of the related business, which is the past business records relating to the key request information, are included in the business contents information, such as when related words exist in the text of the past business records. For example, if the business records that include related words are given a positive valuation, the degree of relevance increases by a given amount. On the other hand, when given a negative valuation, the degree of relevance decreases by a given amount. Through this kind of process, the adaptability, to be calculated next, increases or decreases according to the degree of evaluation of the business records.

The evaluation of the business records may be undertaken in several steps. In this case, it is preferable to change the span of adjustable range of the degree of relevance according to the evaluation steps.

Also, as described earlier, the in-house evaluation and the outside evaluation are provided to the business records. Both of the evaluations may be processed independently. The adjustments by the in-house evaluation and by the outside evaluation are made independently, or the degree of relevance may be adjusted by using the evaluation of both the in-house and the outside evaluation.

An adaptability-calculating unit 76 calculates the total adaptability of the used keywords to the business contents information by statistically using the degree of relevance of several related words, after adjusting the degree of relevance in the record valuation-reflecting unit 78. According to the present embodiment, the sum of the degree of relevance is calculated as the size of the adaptability.

Next is the explanation of an adaptive function-deciding unit 72 of the adaptive function-selecting unit 22. The adaptive function-deciding unit 72 selects business functions, which are applied to clients' needs, which are the adaptive functions, based on the adaptability obtained from the process described above. A plurality of adaptive functions is selected in the present embodiments. A given number of business functions of which the adaptability is bigger, five business functions for example, are selected. Or the business functions, which have more than a pre-determined level of the adaptability, may be selected. A priority order depending on the level of the adaptability will be given for a plurality of the adaptive functions selected in this way.

The adaptive function-selecting unit of the present embodiment was described above. According to the present embodiment, appropriate business functions may be selected by evaluating the adaptability of the clients' needs to the business contents information.

In the present embodiment, the business contents database is composed of writings, which are descriptions of business functions and the aggregation of texts. These writings reflect the knowledge of the person in charge of the applied function. Knowledge information of each business function is included as appropriate in the business contents information by using the writings. Knowledge information, which cannot usually be obtained from a database composed of tables having normal data for each item, may now be obtained.

In the field of knowledge management, knowledge may be classified into explicit knowledge, which is easy to stereotype, and implicit knowledge, which is hard to classify. According to the present embodiment, the database is composed of writings, which cannot be stereotyped, and thereby the knowledge, which is implicit knowledge, may also be incorporated into the database. Particularly, one feature of functions of a general trading company is to make free use of implicit knowledge. The present embodiments have an advantage in that they may deal with the implicit knowledge in the system.

In the present embodiment, by using such a business contents database and based on the sentence-searching technique, adaptive functions may be obtained by retrieving the relative words and by searching for similar words. Here, similarity searching of the concepts using natural language, which is not a mere keyword-search, is performed. The adaptability of the business contents database to the key request information of the clients are obtained by the matching techniques of natural language.

To describe further, in the present embodiment, the clients' needs are presented conceptually, together with a plurality of key request information. In other words, the clients' requests have concepts covering several key request information areas. On the other hand, the business contents information represents the business functions conceptually by way of sentences, and the knowledge, which is typical of the functions, is included in the business contents information. Each piece of key request information is compared with the complete business contents information, and the related words are searched. The related words are searched for each of a plurality of the key request information. Through this process, the concept of the clients' needs and the business functions are compared. When apart or all of the business function resembles the client's needs, it is considered that many related words exist and that the adaptability is high.

Here, tables with many items are used in the conventional general searching-technique. The keywords are compared with the items previously decided in the tables, and estimation such as, “if the data of applied items coincides with keywords, it has adaptability”, is made.

On the other hand, according to the present embodiment, the key words are compared with the business contents information. The keywords are compared not with one item in the table but with the whole business contents information, or with the concepts of the business contents, which are made up of sentences. By this kind of comparison, the relevance of the keywords and the business functions may be assessed. These comparisons are made for each of a plurality of keywords, and those results on the whole are to be considered. In this process, the adaptability between the concepts of the client's needs and the business functions is calculated as described above. It makes possible to appropriately connect the knowledge section of the business functions with the clients' needs.

It is described above that the keywords are compared with the whole business contents information. This is just an expression to indicate that it differs from a mere comparison of the table items. The keywords are not necessarily exactly compared with the whole business contents information. It is good enough that the keywords are compared with the aggregation of sentences, to the extent that the business functions may be expressed conceptually, if anything.

Besides, in the present embodiment, when the adaptability of the client key request information to the business contents information is calculated, the past business records and their evaluations are reflected. If the evaluations of business records are high, it is considered that the adaptability is high. If the evaluations of the business records are low, then it is considered that the adaptability is low. Therefore, the system may judge the adaptability appropriately, and an appropriate function may be presented to the clients.

### “Modification of the Process in the Adaptability Evaluation”

As to the process in the adaptability evaluation, it is possible to make various modifications within the scope of the present embodiments. Here are some examples.

(1) A modification of the process, which reflects the evaluation of the business records, will be described here. In the process described above, the related words having more than a pre-determined level of relevance may be obtained by the typical way. The degree of relevance of the related words is then modified according to the evaluation of the business records.

On the other hand, as to words included in the business records, the degree of relevance may be adjusted according to business evaluations. Suppose a certain word has a low degree of relevance with respect to the keywords by way of the typical process and is not selected as a related word. However, this word may be selected as a related word as a result of the process according to the record evaluation.

(2) The evaluation of the business records may also be reflected in other ways. For example, before evaluating the business records, the adaptability may be calculated by the adaptability-calculating unit 76. In the example described above, the sum of the adaptabilities is calculated, and then when the related words exist in the business records section, the adaptability is adjusted to reflect its evaluation.

(3) As a modification of the statistical process in the degree of relevance of a plurality of related words, it is good to present the degree of adaptability according to the number of related words. In this case, it is preferable that the number of related words is calculated differently according to the record evaluation. For example, when given a positive evaluation, one related word is calculated twice. Also, as in (2) above, record evaluation may be reflected after calculating the adaptability.

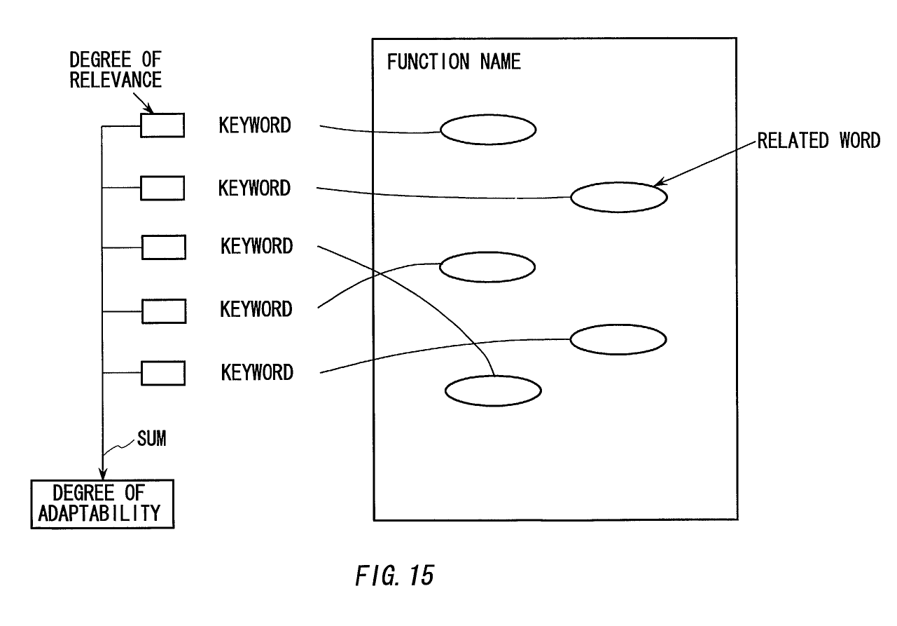

(4) FIG. 15 shows another example of the modification. Here, keywords are used as a criterion. When a word related to a keyword is obtained in the business contents information, the degree of relevance is given to the keyword. If a plurality of related words are obtained, all of the related words may be given to the keywords, or only the keyword, which has the highest degree of relevance, may be given to the keywords. By processing the degree of relevance given to all the keywords this way, the sum of the adaptability will be calculated. In the case of this modification also, the record evaluations are also reflected in the adaptability. When the related words corresponding to the keywords exist in the business records, the adaptability is adjusted according to the evaluation of the applied record. Actually, this modification is practically the same as the process described above.

(5) It is enough that only business records are reflected, and the degree of the evaluation does not need to be reflected. In this case, if the related words exist in the business records, the adaptability will be adjusted. Preferably, when the related words exist in the business records, the adaptability increases. In the business contents information section, the degree of evaluation does not require specially set items.

### “The Adaptability Adjustment According to the Conditions of the Business Functions”

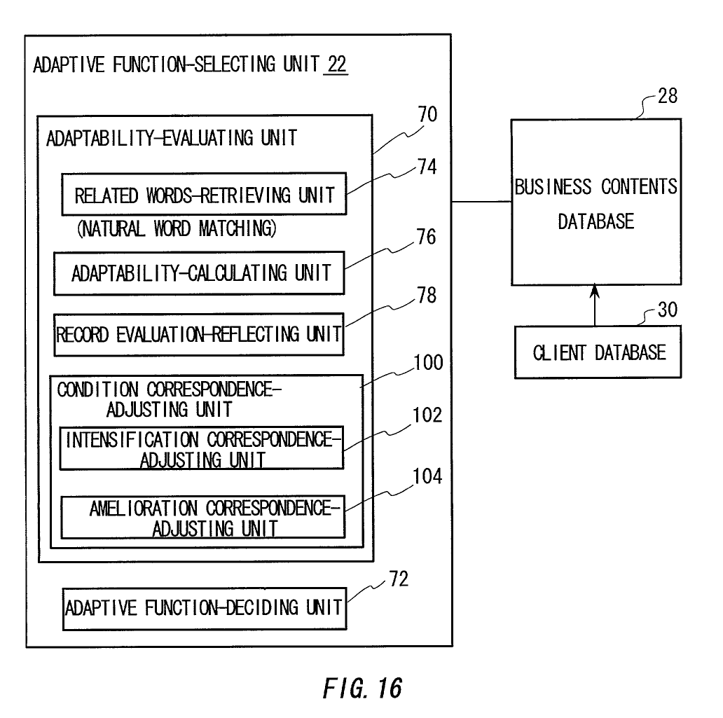

FIG. 16 shows the other form of the adaptive function-selecting unit 22. In this form, a condition correspondence-adjusting unit 100 is established in the adaptability-evaluating unit 70. The condition correspondence-adjusting unit 100 adjusts the adaptability according to the adjustment-objected sections based on the conditions of business functions. According to the present embodiment, an intensification focus section 106 based on an intensified condition and an amelioration focus section 108 based on an ameliorated condition are applied as the adjustment-objected sections based on the conditions of the business functions. Corresponding to both conditions, an intensification correspondence-adjusting unit 102 and an amelioration correspondence-adjusting unit 104 are established.

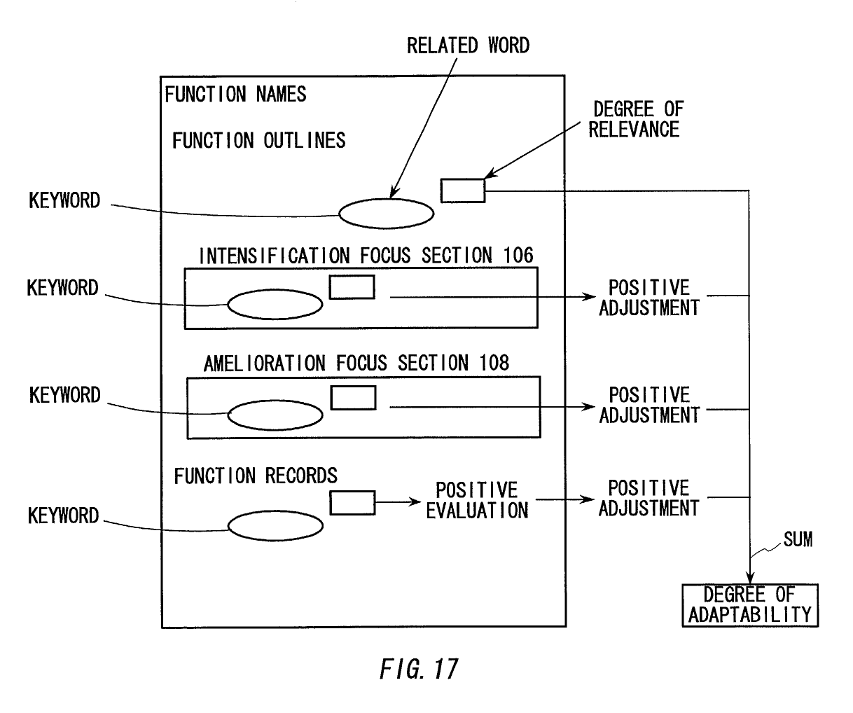

By referring to FIG. 17, the process of the condition correspondence adjustment is described. FIG. 17 shows an example of the business contents information. The intensification focus section 106 is established in the business outline section. The intensification focus section 106 is the part, which is focused in order to intensify the section. As to the business in the intensification focus section 106, it is planned that the business will be driven forward aggressively by investing and reinforcing the human resources and such. As to the intensification focus section 106, the period may be limited.

The intensification correspondence-adjusting unit 102 judges whether or not the related words, which belong to the intensification focus section 106, exist in the related words detected by the related words-retrieving unit 74. If such related words exist, the degree of relevance of the related words is increased to a given amount. Through this kind of process, the adaptability that summed up the degree of relevance increases, and thus the intensified condition of the business functions are reflected in the adaptability.

It is desired that the adaptive functional candidate-selecting unit 60 limit the number of business functions that may be designated as the intensification focus section 106 within a predetermined range, such as approximately 20 percent of the total numbers of the adaptive candidates. This is because it is not preferable that all of the business functions that should be presented to clients be only business functions having strong relationships with the intensification focus section 106.

In FIG. 17, the amelioration focus section 108 is also established in the business outline part. The amelioration focus section 108 is the part that has been improved for the business functions. After having registered the amelioration, the period, which is to be set as the amelioration focus section 108, may be limited.

The amelioration correspondence-adjusting unit 104 judges whether or not the related words, which belong to the amelioration focus section 108, exist in the related words that were detected by the related words-retrieving unit 74. If such related words exist, the degree of relevance of the related words is increased to a given amount. Through this kind of process, the adaptability summed up by the degree of relevance increases, and thus the intensified condition of the business functions are reflected in the adaptability.

According to the process described above, the adaptability is adjusted depending on the conditions of business functions, for example, the intensification and the amelioration of business functions. For example, suppose a similar part is included in the two business functions. When one business function of the part is in the intensified condition or the ameliorated condition, that business function is considered to have the higher adaptability. In this way, the adaptability is appropriately calculated depending on the condition of the business functions.

In the present embodiment, the intensified condition and the ameliorated condition were taken up as the conditions of business functions, but this invention is not limited to these conditions. Other adjustment-focused sections may be established based on the conditions of the business functions. The past business performance described above and also the new business contents section described later may be considered to be one form of the adjustment-focused section.

Moreover, various modifications related to the business performance described above may be applied as the condition correspondence-adjusting process. For example, the adjustment of the adaptability may also be made at the phase of calculating the adaptability, not at the phase of calculating the degree of relevance, and when the adaptability is represented by the number of related words, the process of calculating the numbers may be adjusted.

Besides, at the phase of calculating the degree of relevance, the calculated values may be adjusted with respect to the related words of the adjustment-focused section. In this case, with respect to the adjustment-focused section, broader words than usual are elected in the degree of relevance, and as a result, the adaptability will be adjusted. These processes are also included in the process of this invention, which adjusts adaptability based on the relevance of the keywords and the adjustment-focused section.

These modifications are also applicable when the adaptability is calculated differently, at the process relating to the new business contents described below.

### “The Process of the New Business Contents Section”

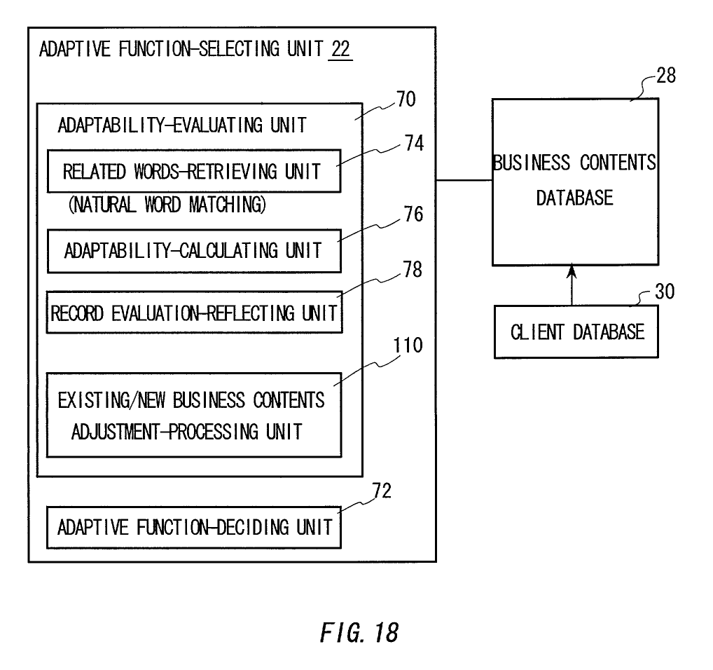

FIG. 18 shows the other form of the adaptive function-selecting unit 22. In this form, an existing/new business contents adjustment-processing unit 110 is established in the adaptability-evaluating unit 70.

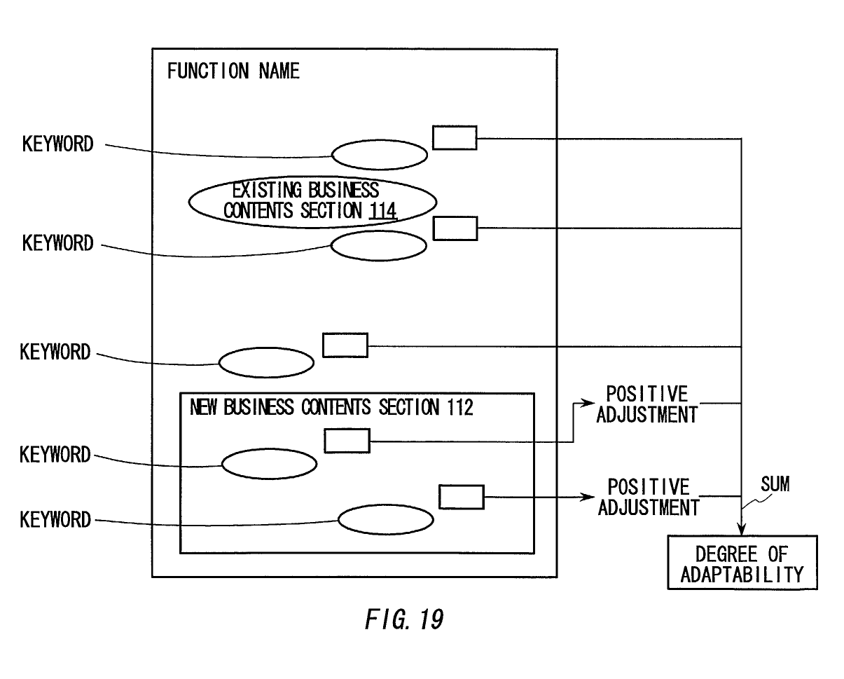

The process using the existing/new business contents adjustment-processing unit 110 is described by referring to FIG. 19. FIG. 19 shows an example of the business contents information, and a new business contents section 112 is established in the business outline section. The other part is the same as those described earlier such as in FIG. 11 and is an existing business contents section 114, which is already established in the business functions.

The new business contents section 112 is the business contents section intended to establish new business functions. These functions may be under consideration or in pre-consideration. When the department or the person in charge of business functions wants a new business, the business will be registered.

The existing/new business contents adjustment processing unit 110 judges whether or not the related words, which belong to the new business contents section 112, exist in the related words detected by the related words-retrieving unit 74. If such related words exist, the degree of relevance of the related words is increased to a given amount. Through this kind of process, the adaptability that summed up the degree of relevance increases, and as a result, the adaptability is adjusted.

In the present embodiment, when the related words belong to the new business contents section, the adaptability increases. Therefore, the possibility of connection between the business functions and the clients with regard to the new businesses for which a business function is desired, becomes higher. It makes it possible to offer the most current services to the clients. Since the clients are assigned to the new businesses, the advantage of the expansion of the new businesses is promoted and the aggressive activities of the new businesses are also promoted, which may be obtained from the business functions.

Moreover, in the present embodiment, the business contents information is composed of sentences and natural language matching will be performed. Having compared to the existing business contents section in which abundant information has been accumulated, information in the new business contents section is generally less. In this case, the probability of finding related words to the key words from the new business contents section becomes low. Thus, it is possible to view the adaptability regarding the new business contents section as low. However, in the present embodiment, since the adaptability regarding the new business contents section is adjusted and increased, the appropriate adaptability evaluation will be made, which considers the difference in amount of information between the new parts and the existing parts. For instance, suppose two business functions have similar functions, and one is in the new part and the other is in the existing part. In this case, by making an adjustment of the adaptability, a more fair result of the evaluation may be obtained.

A modification of the present embodiment will be described in the following. According to the embodiment described above, when the related words to the keywords are in the new business contents section, the adaptability increases. On the other hand, the adaptability may be valued as low when the related words are in the new business contents section. It is useful when it seems better not to evaluate the adaptability as high with regard to the new business contents section for some reason, for example, when the new business contents section is unstable.

In addition, instead of increasing the degree of relevance of the related words belonging to the new business contents section, the degree of relevance of the related words belonging to the existing business contents section may be decreased. Or by installing a weighting to the calculating process of both sections, the result of the calculation may be differentiated depending on which section the related words belong to.

### The Function Presentation-Processing Unit

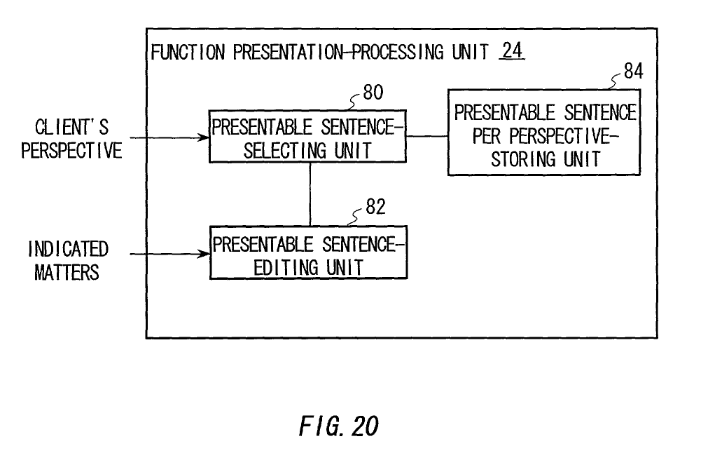

FIG. 20 shows a structure of the function presentation-processing unit 24. The function presentation-processing unit 24 presents to clients the business functions offered to the clients that the adaptive function-selecting unit 22 had selected. The function presentation-processing unit 24 includes a presentable sentence-selecting unit 80, a presentable sentence-editing unit 82, and a presentable sentence per perspective-storing unit 84.

The presentable sentence-selecting unit 80 selects sentences that should be presented to the clients from among the presentable sentences stored in the presentable sentence per perspective-storing unit 84. In the presentable sentence per perspective-storing unit 84, appropriate presentable sentences per each business function are stored. Especially according to the preferred embodiment, for each business function, a plurality of presentable sentences corresponding to the different client perspectives is stored.

The presentable sentence-selecting unit 80 corresponds to the functions selected by the adaptive function-selecting unit 22, and reads the presentable sentences corresponding to the clients' perspective from a presentable sentence per perspective-storing unit 84. Since the adaptive function-selecting unit 22 selects a plurality of adaptive functions, the presentable sentences corresponding to each function are read.

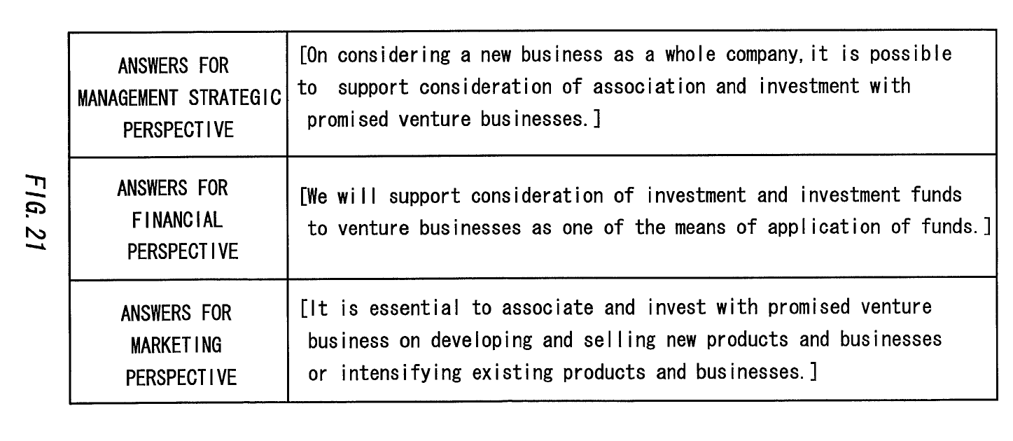

FIG. 21 shows an example of the process for selecting the presentable sentences. Suppose the “venture capital” is selected as a business function by the adaptive function-selecting unit 22. For example, the answers, or presentable sentences, of the management strategic perspective, the financial perspective and the marketing perspective are stored in this function. Suppose the clients' perspective, which is obtained from the process described above, is the management strategic perspective. In this case, the answers for the management strategic perspective are selected.

A presentable sentence-editing unit 82 edits the presentable sentences selected by the presentable sentence-selecting unit 80. In the process described above, a plurality of presentable sentences corresponding to a plurality of adaptive functions is selected. Those presentable sentences are deployed in the order according to the priority order of the adaptive functions. This priority order is given by the adaptive function-deciding unit 72 according to the degree of the adaptability as described above. Moreover, as described earlier, at the request-receiving unit 20, those matters that should be indicated to clients are obtained by using the questions made for the clients. These indicated matters are received, and then the indicated matters are added to the presentable sentences made for the clients. The presentable sentences, which have been edited in this way, are presented on the browser screens of the client terminals 18.

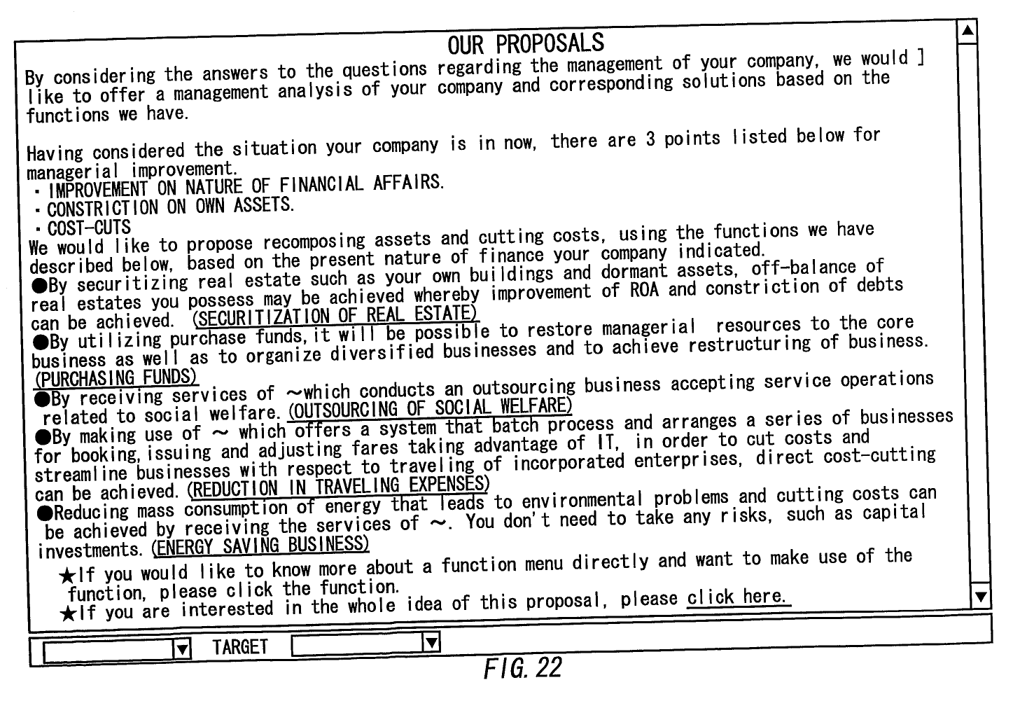

FIG. 22 shows an example of a screen page, which is to be presented to the clients. The upper part shows the indication matters made for the clients, and the lower part is deployed by the presentable sentences, which show functions being presented by the adaptive functions. The presentable sentences are deployed in the priority order of the functions, and each presentable sentence corresponds to the clients' perspectives.

Each presentable sentence is shown with the function names. These function names may be selected by the clients and are used in the process of offering the functions described later. The part which says, “If you are interested in the whole idea of this proposal, please click here” at the bottom, is used in the process described later.

Depending on the key request information, such cases may occur as when answers that are suited to the clients' perspectives are not in the business functions and thus clients' perspectives cannot be obtained, when the total points of more than two perspectives become the same points though perspectives may be obtained, or when corresponding business functions are not found. In these cases, the function presentation-processing unit 24 may present standard answers (neutral presentation sentences) that are previously prepared or instruct clients to previously select desired perspectives and use the selected perspectives.

So far, the process of presenting the functions of the present embodiment has been described. According to the present embodiment, by using the presentable sentences, functions, which are suited to the clients' needs, may be presented to the clients intelligibly. By complying with the priority order of the adaptive functions, information may be presented more appropriately. Moreover, by selecting the contents presented based on the clients' perspective, information that client seeks may be presented appropriately. Further, the appropriate indication matters may be conveyed.

### The Business Operation-Processing Unit

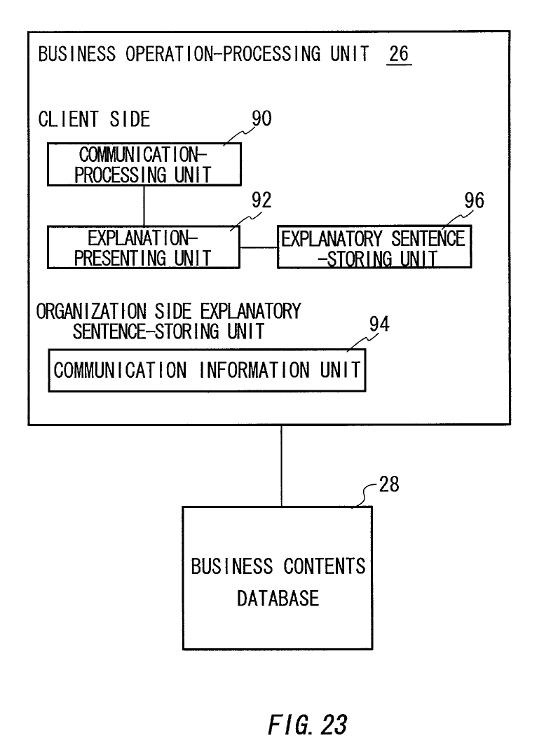

FIG. 23 shows a structure of the business presentation -processing unit 26. The business presentation-processing unit 26 undertakes the process of providing the business functions on receipt of the requests for the business functions from the clients who received a presentation of the business functions. The business presentation-processing unit 26 includes a communicating information-processing unit 90 on the client side, an explanation-presenting unit 92 and a communicating information unit 94 on the business-supporting organization side.

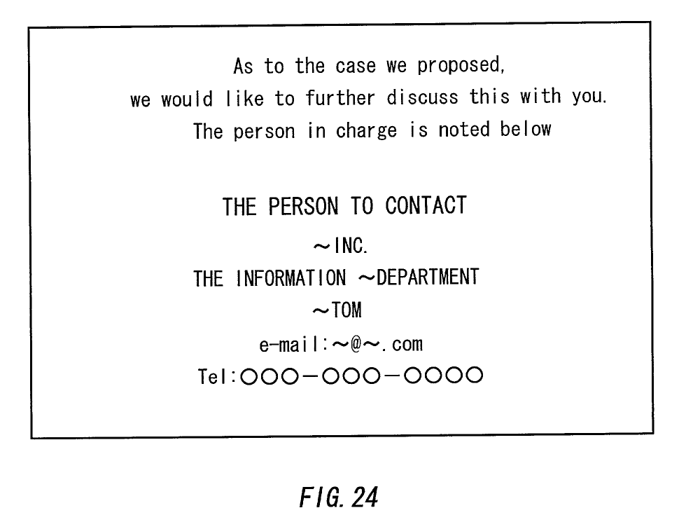

Referring to FIG. 22 again, at the bottom of the proposal page made for clients, it says, “If you are interested in the whole idea of this proposal, please click here”. The clients who are interested in the whole idea of the proposal and who want to have further discussions click the “click here” button as an operation of entry for the business operation requests. By answering this operation, the communicating information-processing unit 90 applies a person in charge for consulting. Here, a person who may consult for the whole proposal should be in charge instead of those who may consult for only each function. A database for suitable people in charge of consulting may be established, and the person in charge may be allotted from this database. The person in charge is presented to the clients as a communicating person. The business operations for the clients are promoted by using e-mails, telephone, meeting directly and such. FIG. 24 shows one of the examples of the screen pages for presenting the contactable telephone number and the e-mail address.

In FIG. 22, function names are added to each function-presenting sentence and function names may be selected by the clients. When a client wants to know further about each function in the proposal, the client clicks on the function name. By answering this clicking, the explanation-presenting unit 92 presents a detailed explanation of the applied function to the client. The detailed explanation of each function is stored in an explanatory sentence-storing unit 96.

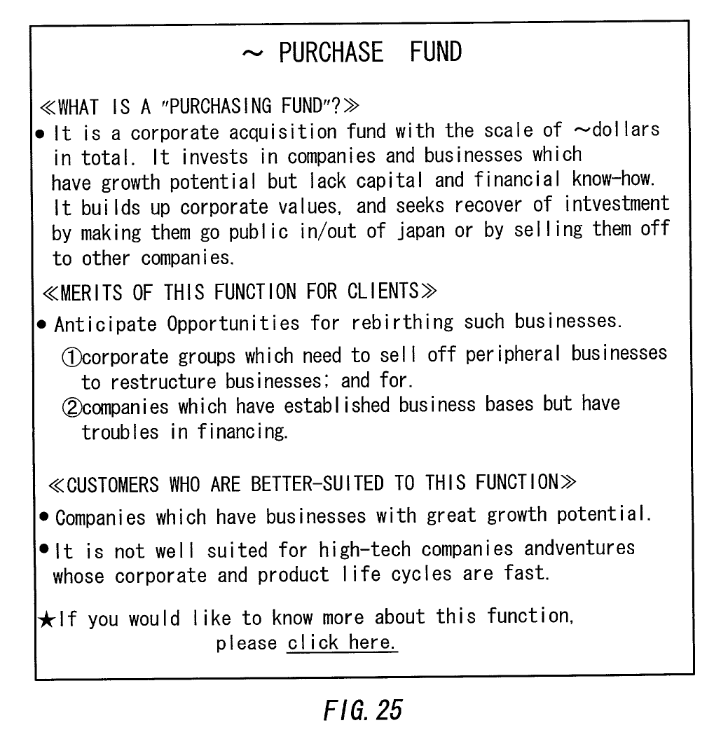

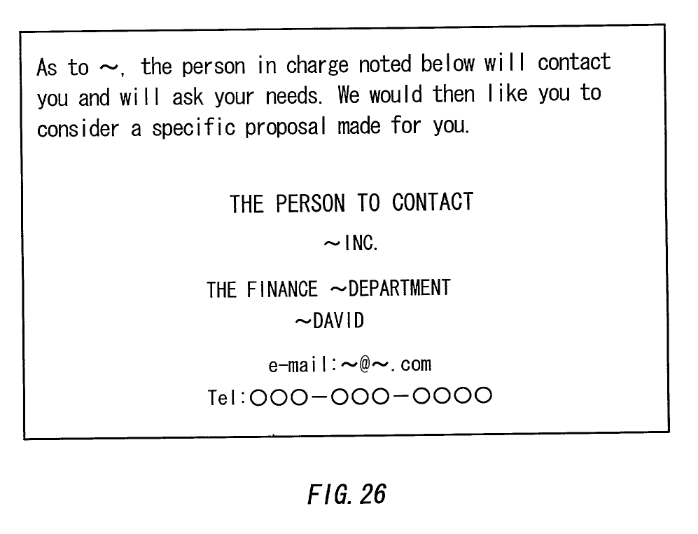

FIG. 25 shows an example of an explanatory screen page. This page is presented on the clients, terminal. At the bottom of the page, it shows, “If you would like to know more about this function, please click here.” When a client wants to implement the presented function or considers it for further discussions, he/she clicks the “click here” button. By answering this clicking, the communicating information-processing unit 90 refers to the business contents database and presents the communicating information of the department in charge of the function. The department in charge directly accesses the client. FIG. 26 shows an example of the page for communicating information, which is presented to the clients.

On the other hand, the communicating information unit 94 of the business-supporting organization side undertakes the process for communicating information to the allotted department in charge. The contents of the communication includes the client's inputs, or answers to questions, and its analysis information. The analysis information is, for example, the priority order of the client's needs—a priority order is given to keywords that are applied from the questions based on the order of frequency; the functions that fit to the needs—a plurality of business functions obtained by the adaptability evaluation; the combination of the putative functions; and the proposal itself. The contents of the communication include the information of each applied function, such as contents of the functions and the past performances of the functions. Moreover, the contents of the communication include similar information searched from the analysis information described above, such as the similar past needs, the contents of the proposal with respect to the needs and its evaluation, the department in charge, and the person in charge. In addition, the department and the person in charge who have similar functions to the applied functions are searched and communicated. This information may be presented to the clients also.

### The Database-Updating Unit

With reference to FIG. 3, the business-supporting server 14 of the present embodiment also has a database-updating unit (rewriting unit) 27. Now, the database-updating unit 27 will be described. The database-updating unit 27 updates, or rewrites, the business contents database 28 when requests for various updating, or rewriting, of the business contents information in the business contents database 28 are received.

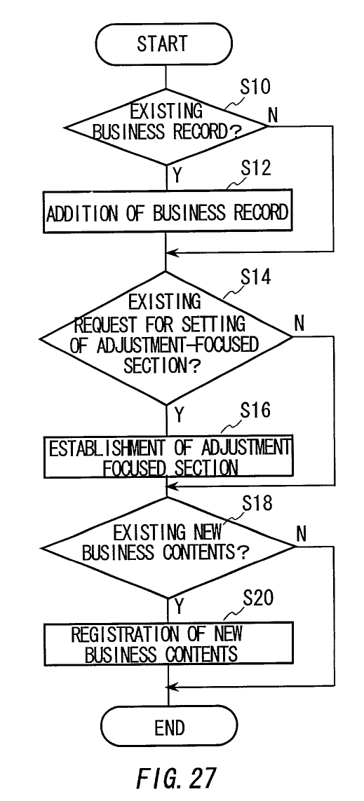

FIG. 27 shows a process of the database-updating unit 27. This process is initiated using an inquiry to the person in charge when, for example, the person in charge of each function accesses the server and selects the updating process. The process described in FIG. 27 may be automatically executed at regular intervals.

At S10, it is judged whether or not a new business record occurred. As described using FIG. 11, according to the present embodiment, the business records are included in the business contents information by way of case examples. When a new business record is obtained at S10, the business record is added to the business contents information at S12. When an evaluation of the business record is obtained, the judgment of S10 becomes YES, and the business contents information is updated as well.

The next process at S14 is judging whether or not the setting of the adjustment-focused section is required. This process is applied to the present embodiment described in FIG. 16, that is, the embodiment that evaluates the adaptability using the adjustment-focused section. The adjustment-focused section is the section, such as the intensification focus section of the functions and the amelioration focus section. When intensification of a part of the functions was planned and amelioration is made, the need for setting of the adjustment-focused section occurs. In response to these needs, the adjustment-focused section will be established in the business contents information at S16. Meanwhile, “updating” described here means the process of rewriting the database, and it's the process that strengthens the functions described above, that rewrites the database according to the intensifications or the ameliorations described above, that registers the setting, and that reflects the intensifications or the ameliorations to the database.

S18 then judges whether or not setting of the new business contents are needed. This process is applied to the present embodiment described in FIG. 18, that is, the embodiment that evaluates the adaptability using the new business contents section. The new business contents section is the business section that business functions intend to install. When an advancement of these new businesses is planned, a need for setting the new business contents section occurs, and the judgment of S18 becomes YES. In response to this request, a new business contents section is set in the business contents information at S20.

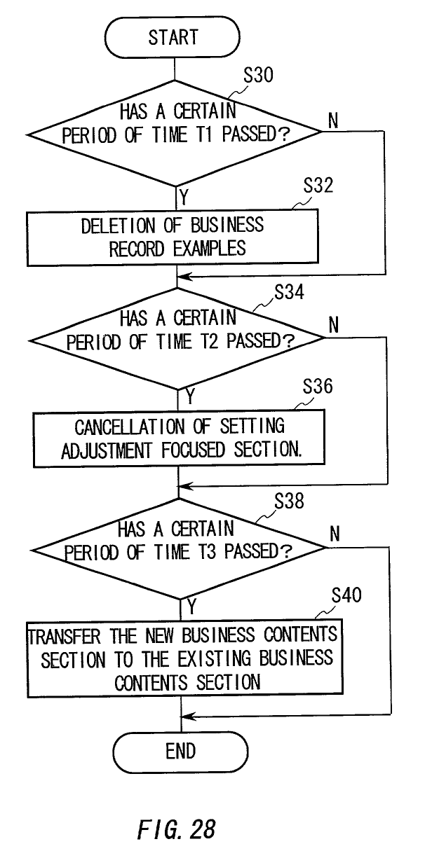

FIG. 28 shows a more appropriate process of the database-updating unit 27. There is a case where it is not preferable to leave the result of the updating, which followed the process described in FIG. 27 as it is. For example, because the obsolete business records which should not be used for judging the adaptability, may remain. Another example is because the ameliorated parts tend to be over emphasized, even though a lot of time may have passed since the amelioration. So, to resolve this problem, the setting made by the updating at FIG. 27 is re-modified by a process such as the deletion and the cancellation.

At S30 of FIG. 28, it is judged whether or not the given period of time T1 has passed since the registration of the business records at S12 of FIG. 27. When the given period of time T1 has passed, the business records are eliminated from business contents information at S32. The business records may be modified from the embodiment of cases to the general embodiment, and may be combined with other outline parts of the functions.

The given period of time T1 is set for the length of time after which an applied business record is considered as not appropriate to use in the adaptability evaluation. The given period of time T1 may be set for each business function, and also maybe set for each business record as well as for the whole business records in common. The given period of time T1 may be set differently depending on the business evaluation, and may change the length of the period in the time after having registered the business records. The given period of time T1 may be the lapsed time since the actual occurrence of the records.

At S34, it is judged whether or not the given period of time T2 has passed since the setting of the adjustment-focused section. When the given period of time T2 has passed, the setting of the adjustment-focused section is cancelled at S36. The given period of time T2 is set for the period that is considered that the setting of the adjustment-focused section is not wanted. For example, the given period of time T2 is set in accordance with the intensified period in terms of the intensification focus section. In terms of the amelioration focus section, the appropriate length of time, which may be considered that the amelioration is emphasized enough, is set. The given period of time T2 may be set for each business function as the given period of time T1. Moreover, the given period of time T2 may be set for each adjustment-focused section as well as the whole of the adjustment-objected section in common. T2 may change the length of the period in the time after having set the adjustment-focused section. The given period of time T2 may begin the time count from the actual start of the intensification and from when the amelioration actually occurred, instead of from the time of the registration.

Then again, at S38 it is judged whether or not the given period T3 has passed since the setting of the new business contents section. When the given period of time T3 has passed, the new business contents section is moved to the existing business contents section as one form of the cancellation of the update setting at S40. The given period of time T3 is set for the period which it may be considered that the focused business contents section is no longer new. The given period of time T3 may be set for each business function as T1. Moreover, the given period of time T3 may be set for each new business contents section as well as the whole of the new business contents section in common. The given period of time T3 may change the length of the period in the time after having set the new business contents section. The given period of time T3 may begin the time count from the actual start of the new business instead of from the time of the registration.

In the process shown in FIG. 28, during the passage of the given periods from the given periods of time T1 to T3, the updated contents were re-modified at S32, S36, or S40. However, the updated contents may be re-modified according to the requests at a given time.

The above process completes the description of the database-updating process. With regard to information other than information of the business records described above as examples, the updating of business contents information and processes of re-modification may also be made.

As described above, in the present embodiment, the business contents database may be kept under the condition where an adaptability evaluation may be appropriately made.

Preferably, the department or the person in charge of each function accesses the business-supporting server 14, sends data for updating, and requests the deletion or the cancellation of the updated contents. This makes the business contents database update quickly. Other means may also be used, including for example, having the operator of the business-supporting server 14 undertake the updating process.

### Association with Clients Who Acknowledge Their Managerial Tasks

The preferred embodiments described so far are mainly directed towards clients who do not clearly acknowledge their managerial tasks and want to know the adequate functions. On the other hand, for client companies who have already acknowledge their managerial tasks, the process described below is undertaken.

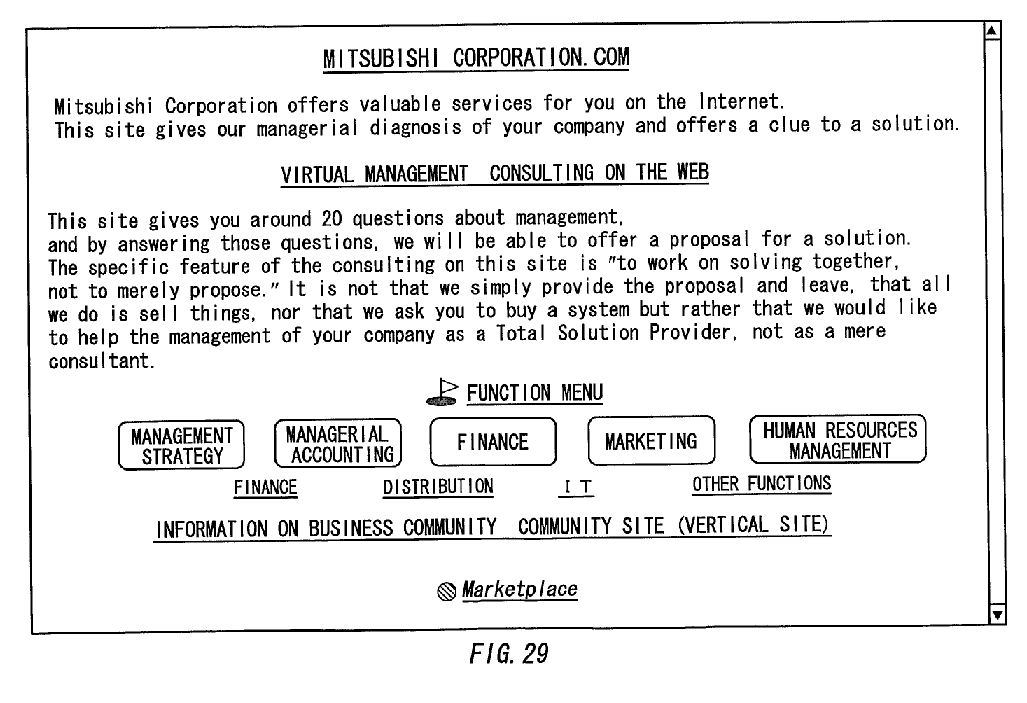

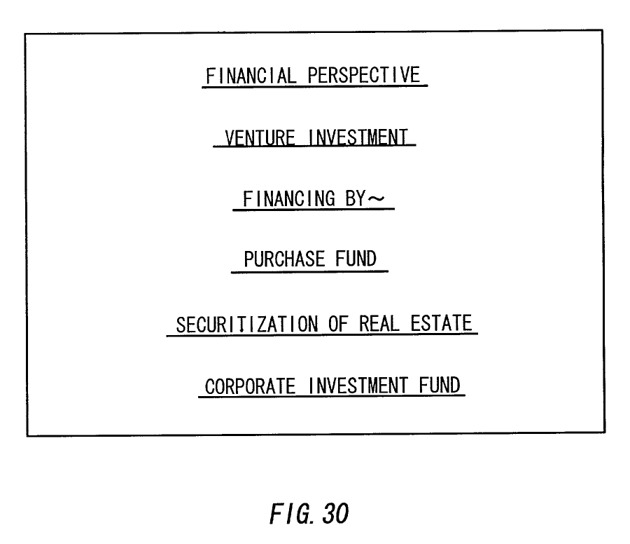

FIG. 29 shows a top menu of this system on the Web. The center of this top menu is“Menu for Functions”, and below it several client perspectives are shown. A client clicks the client perspective, which suits their situation. For example, if the financial perspective is clicked, the screen page of FIG. 30 is presented. A plurality of functions is shown on the screen and a client clicks the desired function(s). Regarding the selected function, the explanatory page described earlier is shown.

### Other Databases

In FIG. 3, the business-supporting server 14 also has a corporation database 32. The corporation database 32 is used for the management of identity confirmation, and for achieving prevention of unauthorized access by other persons in disguise.

It is preferable that the corporation database 30 classifies the results of the client an alysis and the proposals in the database, and that it is composed in such a way that it is able to be applied to similar examples when propositioning a new client.

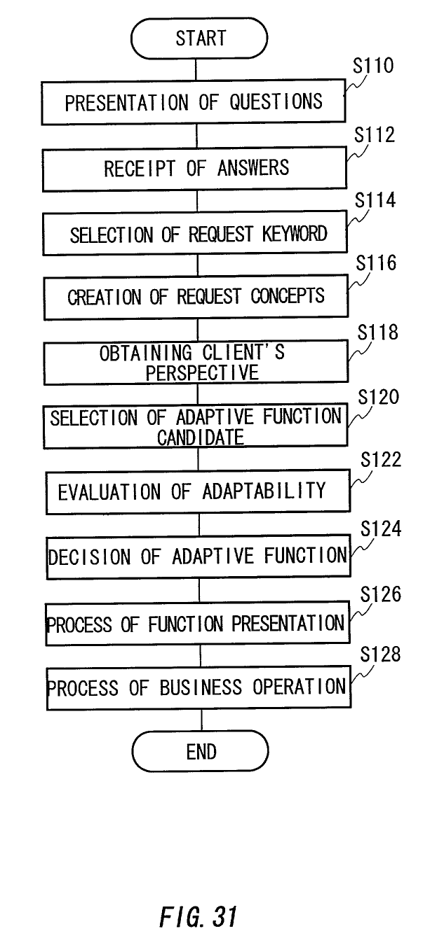

FIG. 31 is a flowchart showing the outlines of the operation of the business-supporting server of the present embodiment. When a client gains access to the server, the questionnaire page is presented to the client at S110 and answers from the client are obtained at S112. By analyzing the answers, the key request information may be obtained. Here, the keywords are selected by using the question items at S114 and the concepts are retrieved from the client's writings at S116. By analyzing the answers, a client's perspective may be obtained at S118. Moreover, the adaptive function candidate is obtained at S120, and using this, the number of business functions is reduced before evaluating their adaptability. Next, the adaptive function candidate as an object, the adaptabilities of the key request information and the business contents information are calculated at S122, and the adaptive functions are decided at S124. The information, which corresponds to the adaptive functions and the client perspective, is presented to the client at S126, and the process for offering business to the client is made at S128.

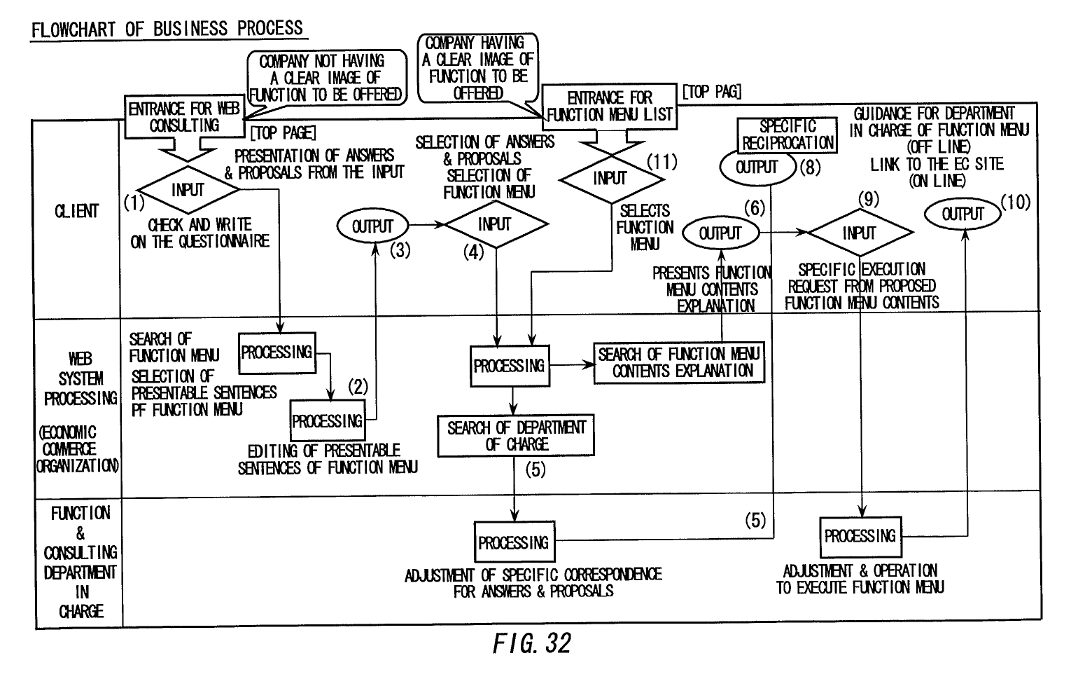

FIG. 32 shows the outlines of the operation of the whole system according to the present embodiment.

(1) A client enters into this system at the entrance located at the upper left and answers the questions offered from the supporting-server, or the Web system. The question items are checked and other requests are described.

(2) The supporting-server analyses the answers to the questions, searches the function menu or the business contents database based on the result of the analysis, and selects the presentable sentences that should be presented to the client from the result of the search.

(3) The answers and the proposals including the edited presentable sentences are presented to the client.

(4) The client selects entire answers and proposals as an entry process or selects one function from among the proposals.

(5) The supporting-server processes the client's entry. If the whole answers and proposals are selected, a corresponding department in charge is searched, a specific association is adjusted, and (8) the specific association made for the client is pursued.

On the other hand, if one of the proposed functions is selected, the explanatory sentences of the function are searched and (6) are presented to the client. (9) When the client enters a request for specific operations of the presented function, the adjustment and the operation for executing the function are made at the applied department in charge, and (10) the department in charge is guided to the client.

(11) Incidentally, clients who know what they should do from the start, that is, who know the function they want to be provided with, enter from the entrance of the function menu located at the upper middle of FIG. 32 and select the required functions. The business-supporting server operates in accordance with the selected functions.

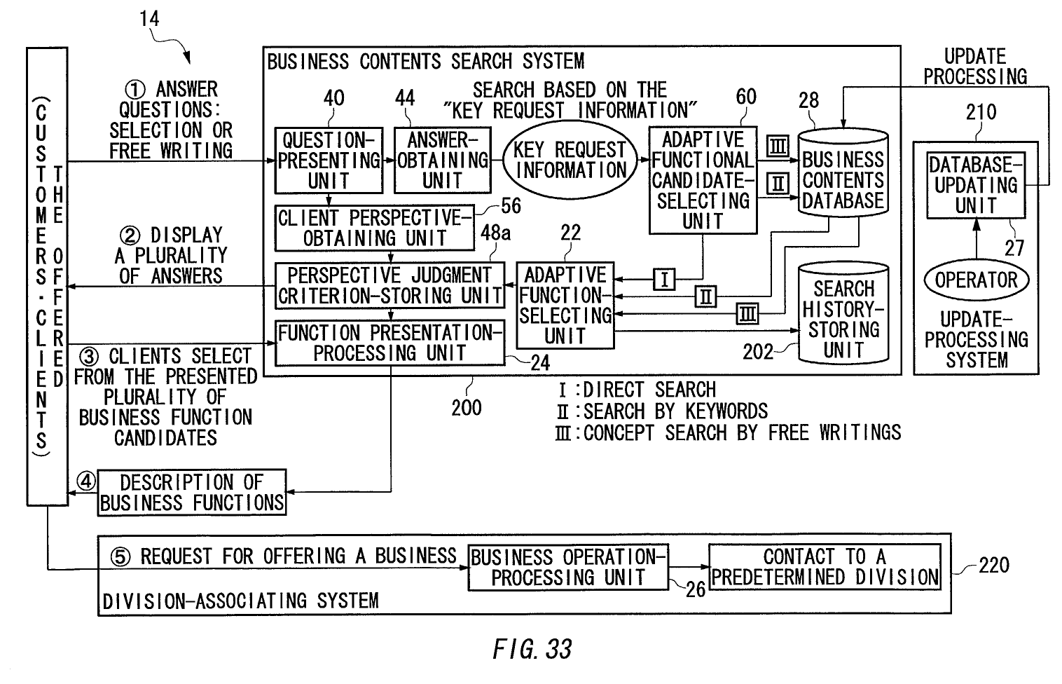

FIG. 33 shows another embodiment of the system 10. The system according to this embodiment includes a business contents search system 200, an update processing system 210, and a division associating system 220. The business contents search system 200 includes a perspective judgment criterion-storing unit 48a, which corresponds to the analysis criterion-storing unit 48 according to the embodiment described above, and a search history-storing unit 202 for storing a search history showing who has and what is selected. Functions of each element unit are almost the same as the functions of each element unit shown in the embodiment described above except for the functions described in the following.

The adaptive function-selecting unit 22 according to the present embodiment “weighs business functions elicited by searching (referred to as a weighted search thereinafter),” adds “a weight according to the condition of each business function (referred to as a weighted adaptive condition thereinafter),” and elicits business functions to be presented to clients. The adaptive function-selecting unit 22 stores the search history in the search history-storing unit 202. The “weighted search” is conducted about business functions corresponding to each of: the questions themselves that are answered by the clients among questions that is previously prepared for eliciting clients' needs (answered questions; I in the drawing) ; keywords that are previously registered associating with these answered questions (II in the drawing); and concept keywords that are retrieved by the concept search from the free writing (character information) entered by clients. The adaptive function-selecting unit 22 uses a weighted index value for adjusting the adaptability by making each of the recency, the intensification, the amelioration, the past records, and the evaluation an object when conducting the “weighted adaptive condition.” Elements other than these elements described above may be objects for weighing. Finally, the adaptive function-selecting unit 22 selects business functions to be presented to clients by putting final weights with the sum total of the points of each weight on the business functions that are retrieved by the weighted search and the weighted adaptive condition.

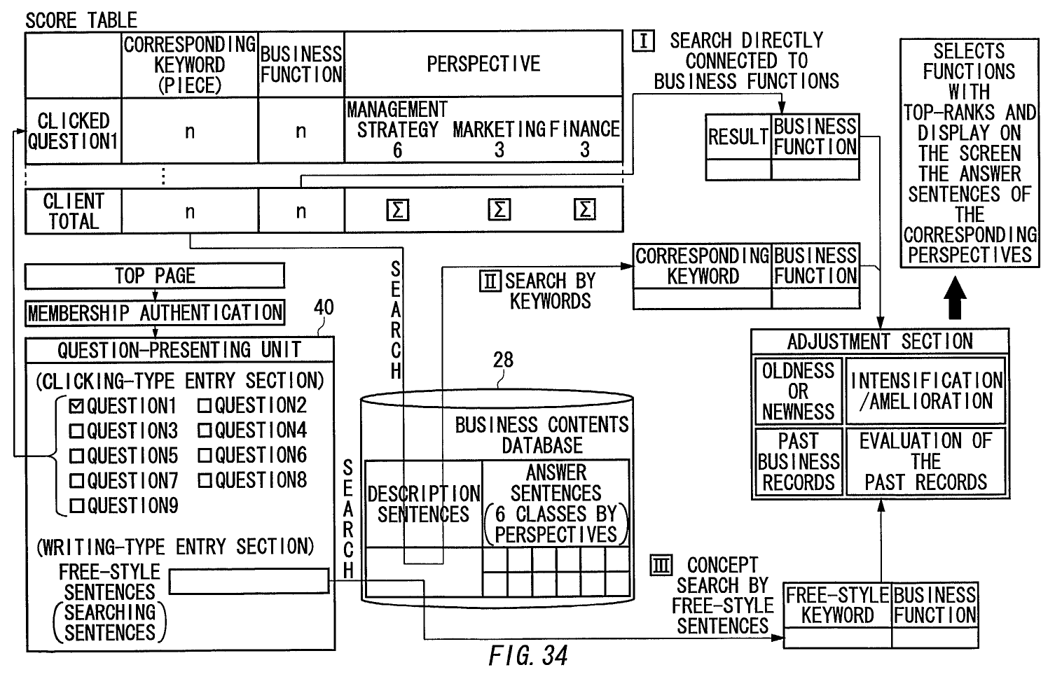

FIG. 34 is a system structural diagram showing the weighted search and the weighted adaptive condition. When a client gains access to the system 10, a top menu is firstly displayed on the browser screen of the client terminal 18. If the client authenticates its membership on the browser screen, the question-presenting unit 40 displays a questionnaire page on the browser screen (for example, the same as FIG. 5 described above) The client answers the questionnaire on the questionnaire page by clicking interested items among each question item of clicking-type entry section (questions 1˜9 in the drawing) that is previously prepared to elicit the client's needs. Moreover, the client writes in the writing-type entry section problem points or points to be improved relating to the management that cannot be described enough with the questions listed on the question items in free style sentences (free writing). The client perspective-receiving unit 56 (FIG. 33) calculates the total points, as a score table, of the points of all perspectives and the points of each perspective corresponding to question items checked by the client, by referring to the perspective point table shown in FIG. 8. By instructing the client to select such as “the most applicable question,” a business function to be finally presented may be selected.

The adaptive function-selecting unit 22 then searches the business contents database 28 and selects business functions adapted to the key request information showing the client's needs. The adaptive function-selecting unit 22 simultaneously searches by freely combining the three search methods: a search of business functions, which are directly connected to the questions answered by the client among the questions that are previously prepared to elicit client's needs (referred to as a direct search thereinafter; I in the drawing); a search by the keywords, which are previously registered associating with the answered questions (H in the drawing) ; and a concept search by free-style sentences entered by the client (III in the drawing).

Further, the adaptive function-selecting unit 22 adjusts the adaptability of presenting business functions by using the weighted index value if the adaptive function relates to the adjustment focus section, such as the recency of the business function and the intensification or the amelioration of sales, when the adaptive function-selecting unit 22 selects business functions adapted to client's needs. Furthermore, the adaptive function-selecting unit 22 also adjusts the adaptability relating to the past business records or the evaluation of the past records (in-house evaluation and the outside evaluation) by using the weighted index value.

The function presentation-processing unit 24 selects functions with top ranks among business functions selected by the adaptive function-selecting unit 22. The function presentation-processing unit 24 then displays the answers sentences of the corresponded perspectives on the browser screen. Therefore, it is easier to propose such as “fresh proposal that have been just updated” or “business functions that are desired to be focused to sell,” for example. Thus, business functions that are suited to clients' needs may be retrieved and proposed.

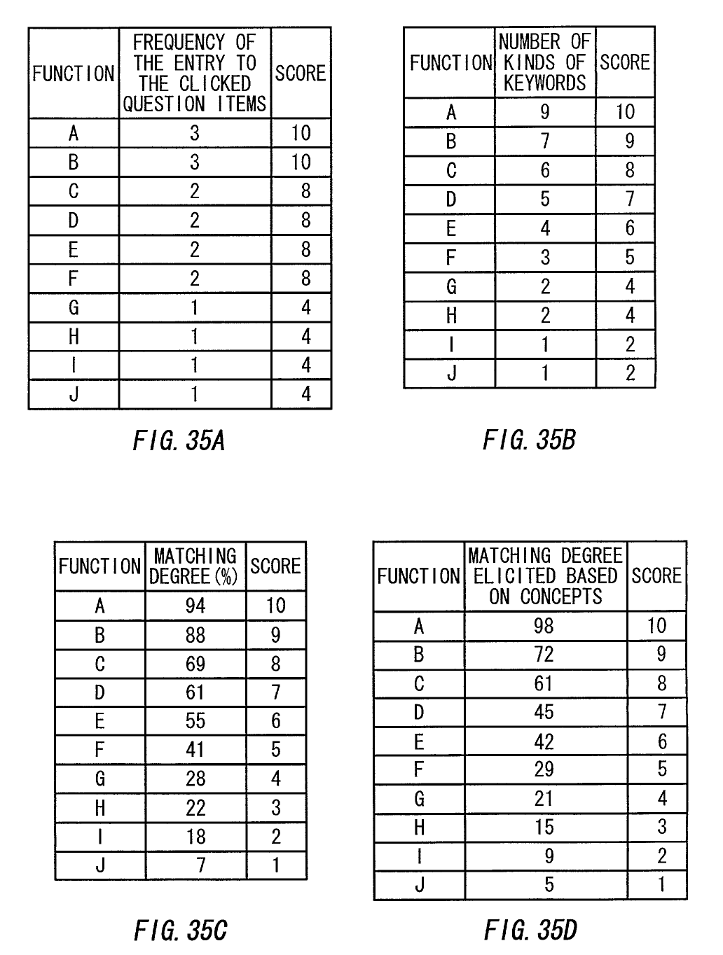

FIG. 35 shows an exemplary method for ordering during a search, that is the method of the weighted search. The adaptive function-selecting unit 22 refers to a predetermined degree to each of: the business functions that are directly associated with questions; keywords that are associated with questions; and the business functions that are retrieved based on the free-style sentences. The adaptive function-selecting unit 22 then evaluates the adaptability of business functions for the key request information. Specifically, the adaptive function-selecting unit 22 firstly retrieves business functions that are applied to the questions clicked by the client, as shown in FIG. 35A, in the direct search. The adaptive function-selecting unit 22 then weighs the corresponded business functions by making the order of the number of the entry as the score. At this time, the weighted index value of a business function with the most frequent entry scores “10” and the weighted index value of business functions with the less frequencies are set sequentially lower.

In the search by keywords, the adaptive function-selecting unit 22 counts as once even if the keywords that are previously applied to each question are clicked more than once. The adaptive function-selecting unit 22 then weighs the corresponded business functions by making the order of the number of the kinds of the clicked keyword groups as the score as shown in FIG. 35B. At this time, the weighted index value of a business function with the largest quantity of kinds scores “10” and the weighted index value of business functions with the less quantities are set sequentially lower. The score may be adjusted as that the weight is “10” for the business function with the number of kinds of more than 10.

In the search by keywords, the adaptive function-selecting unit 22 may retrieve keywords based on concepts, by conducting the concept search based on the question sentences with reference to the database offered by a search service company, for example. After the adaptive function-selecting unit 22 retrieves the corresponded business functions by searching the business contents database 28 using the keywords based on concepts, the adaptive function-selecting unit 22 weighs the corresponded business functions with the order of the matching degree as the scores. At this time, as shown in FIG. 35C, the weighted index value of a business function with the highest degree of the matching scores “10” and the weighted index value of business functions with the lower degree are set sequentially lower.

In the search by the free-style sentences, the adaptive function-selecting unit 22 conducts the concept search by the free-style sentences themselves with reference to the business contents data base 28. After the adaptive function-selecting unit 22 elicits the corresponded business functions based on concepts, the adaptive function-selecting unit 22 weighs the corresponded business functions with the order of the elicited matching degree as the scores. At this time, as shown in FIG. 35D, the weighted index value of a business function with the highest degree of the matching scores “10” and the weighted index value of business functions with the lower degree are set sequentially lower.

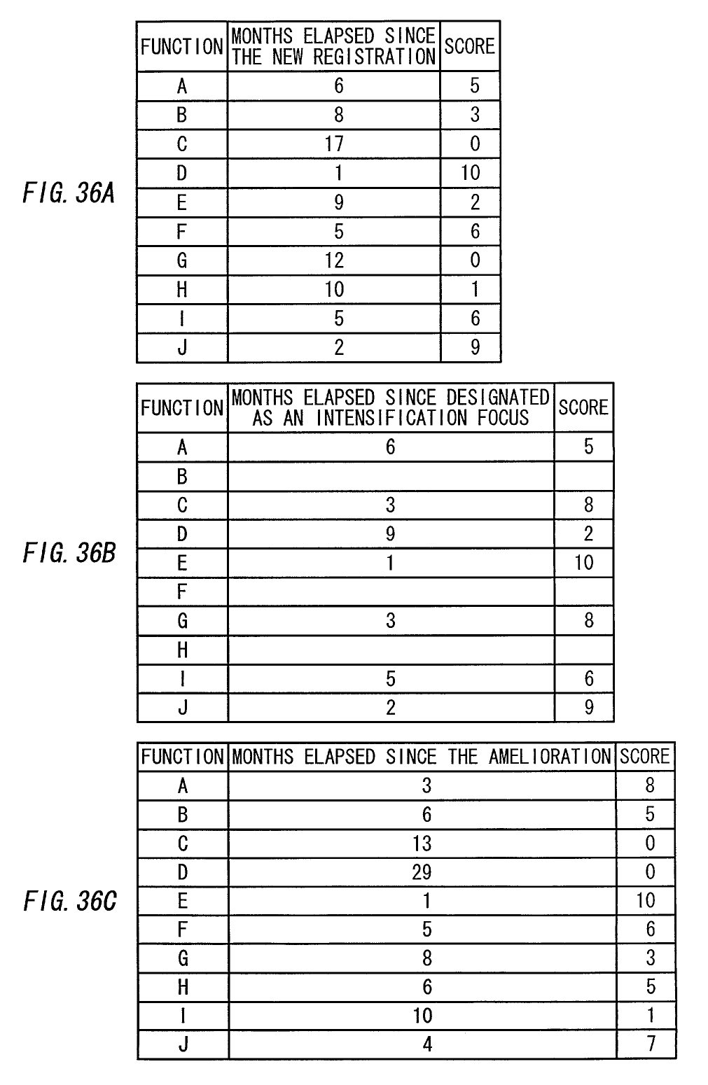

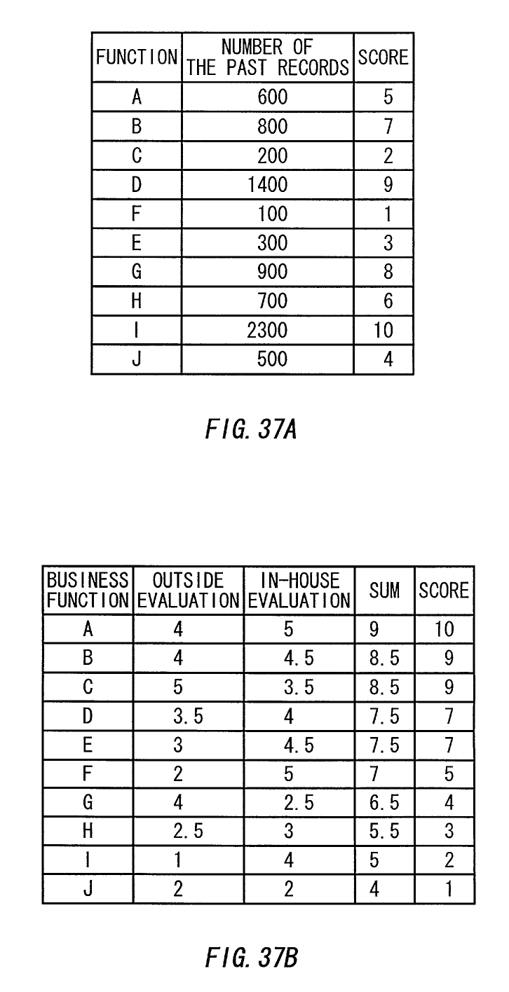

FIG. 36 shows an exemplary method for adjusting the adaptability making the recency, the intensification, and the amelioration, objects respectively by using the predetermined weighted index value for adjusting the adaptability, which is the method of the weighted adaptive condition. In the same way, FIG. 37 shows an exemplary method of the weighted adaptive condition making the past business records and the evaluation (the in-house evaluation and the outside evaluation), objects respectively.

The adaptive function-selecting unit 22 adjusts the adaptability of business functions for the key request information by using the weighted index value according to the time when business contents information is registered to the business contents database 28. In particular, the adaptive function-selecting unit 22 weighs according to the state of the “recency” by classifying and scoring the degree of the recency of the time when a new business function is made. At this time, as shown in FIG. 36A, for example, such as the weighted index value of a business function registered within one month scores “10,” the weighted index value of a business function registered within two months scores “9,” the weighted index value of a business function registered within three months scores “8,” the weighted index value of business functions are set sequentially lower according to the lapse of months. That is, the newer the time when a business function is made, the higher the score of the weighted index value. It is recommended that the weighted index value of the business functions that have lapsed more than ten months score “0.”

The adaptive function-selecting unit 22 adjusts the adaptability of business functions to the key request information by using the weighted index value according to the time when a business function is designated as the intensification focus section (promotion). In particular, the adaptive function-selecting unit 22 weighs according to the state of the “intensification” by classifying and scoring the lapsed time of months to become an object of a promotion. At this time, as shown in FIG. 36B, for example, such as the weighted index value of a business function that becomes to be an object of a promotion within one month scores “10,” the weighted index value of a business function that becomes to be an object of a promotion within two months scores “9,” the weighted index value of a business function that becomes to be an object of a promotion within three months scores “8,” the weighted index value of business functions are set sequentially lower according to the lapse of months. That is, the newer the time when a business function becomes to be an object of a promotion, the higher the score of the weighted index value. It is recommended that the weighted index value of the business functions that have lapsed more than ten months score “0.”

The adaptive function-selecting unit 22 adjusts the adaptability of business functions to the key request information by using the weighted index value according to the time when a business function is ameliorated. In particular, the adaptive function-selecting unit 22 weighs according to the state of the “amelioration” by classifying and scoring the lapsed time of months that a business function is altered or modified (that is, ameliorated). At this time, as shown in FIG. 36C, for example, such as the weighted index value of a business function that is ameliorated within one month scores “10,” the weighted index value of a business function that is ameliorated within two months scores “9,” the weighted index value of a business function that is ameliorated within three months scores “8,” the weighted index value of business functions are set sequentially lower according to the lapse of months. That is, the newer the time when a business function is ameliorated, the higher the score of the weighted index value. It is recommended that the weighted index value of the business functions that have lapsed more than ten months score “0.”

The adaptive function-selecting unit 22 adjusts the adaptability of business functions to the key request information by using the weighted index value according to the number of the past records of offering business functions. In particular, the adaptive function-selecting unit 22 weighs according to the state of the number of the “past offer records” by classifying and scoring the number of times that a client has communicated its will to desire to have a contact to the system 10. At this time, as shown in FIG. 37A, for example, the weighted index value of a business function with the highest number of the past records scores “10,” and the weighted index value of business functions with the lower number of the past records are set sequentially lower according to the lapse of months. That is, the more the number of the past offer records, the higher the score of the weighted index value. The adaptive function-selecting unit 22 may adjust the adaptability of business functions to the key request information by using the different weighted index value according to the degree of newness of the past offer records of business functions, which is the newer the past offer records, the weighted index value is higher, in addition to the example shown in FIG. 37A.

The adaptive function-selecting unit 22 adjusts the adaptability of business functions to the key request information by using the weighted index value according to the degree of the in-house evaluation or the outside evaluation on the business functions that are adapted to the selected clients' needs (the offered). For example, business functions are evaluated by the people inside or outside of the company, and the evaluations are used as a scale of seeing the value of the presented business functions.

For example, a client who has made a deal may be presented a questionnaire having a plurality of questions. The questionnaire is then gathered, and the average score is adopted as the scale of the outside evaluation. Moreover, Self-evaluation of the main department of functions are gathered, and the average score is adopted as the evaluation scale of the in-house evaluation. The questionnaires relating to the in-house evaluations are not only used for weighing, but also the results of the questionnaire may be added to evaluation information mixed with radar charts.

The adaptive function-selecting unit 22 weighs according to the state of the “offer evaluation” by classifying with the scores that totaled each average score of the outside evaluation and the in-house evaluation. At this time, as shown in FIG. 37B, for example, the weighted index value of a business function with the highest total score scores “10,” and the weighted index value of business functions with the lower scores are set sequentially lower according to the lapse of months. That is, the higher the evaluation, the higher the score of the weighted index value. The adaptive function-selecting unit 22 may adjust the adaptability of business functions to the key request information by using the different weighted index value according to the degree of newness of the evaluation on business functions suited to the selected client's needs, in addition to the example shown in FIG. 37B. In this case, the newer the evaluation, the higher the weighted index value.

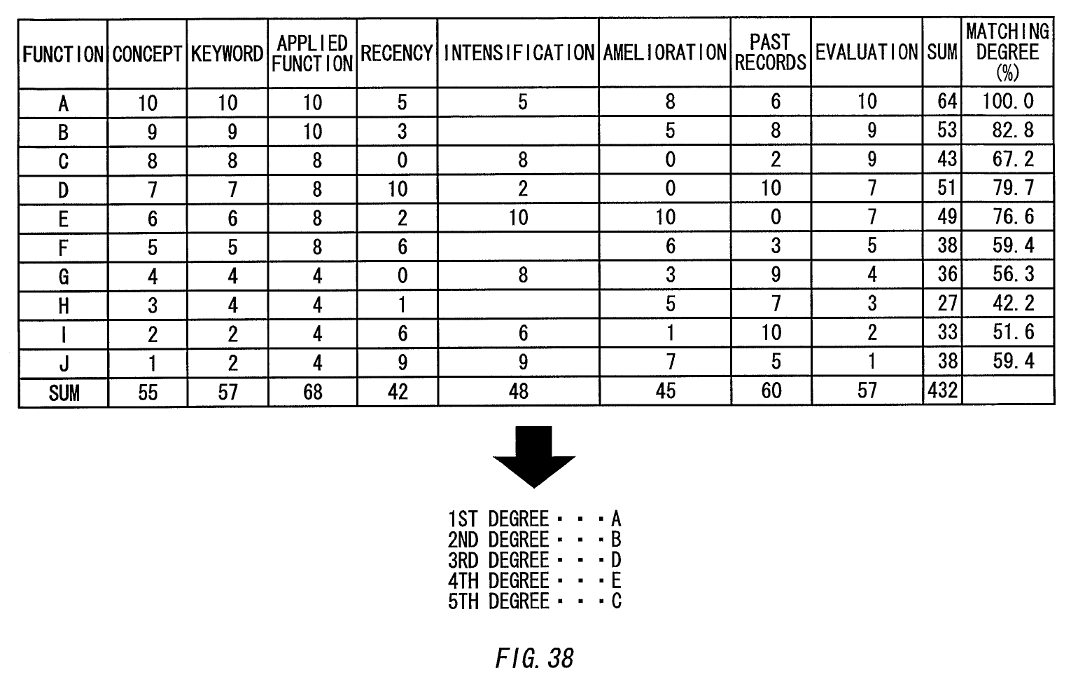

FIG. 38 shows an exemplary method for selecting business functions to be presented to clients based on the weight for each of the total of eight elements of the weighted search and the weighted adaptive condition described above. The applied function in the drawing means a function that is applied by the direct search. The adaptive function-selecting unit 22 calculates the total scores of each weight of the business functions retrieved by the weighted search and the weighted adaptive condition, for the respective business function. The adaptive function-selecting unit 22 then gives a priority order as the business functions to be presented to clients, with the order of the higher total score.

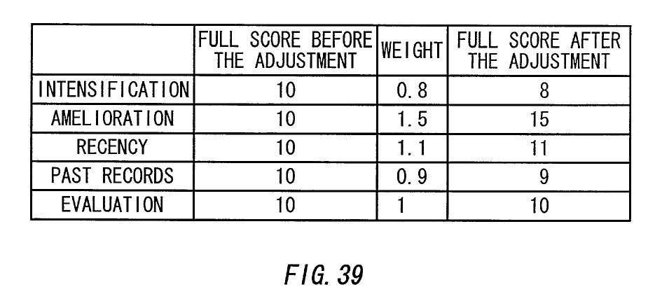

FIG. 39 shows an exemplary method for adjusting the adaptability by adding the priority degree of the five elements relating to the weighted adaptive condition. The adaptive function-selecting unit 22 multiplies the full score (10) of the weighted index value by the weight (degree) according to the priority degree of the five elements. The adaptive function-selecting unit 22 then calculates the full score of the adjusted weighted index value. The adaptive function-selecting unit 22 adjusts the weighted index value of each business function before the adjustment, according to the full score of the adjusted weighted index value. Thus, the adaptability of business functions to the key request information may be adjusted according the priority degree of the five elements. Therefore, by previously setting the priority degree of the five elements, the kinds of business functions to be presented to clients or the adaptability of business functions may be adjusted according to the priority degree. For example, in FIG. 8, which does not consider the priority degree, the priority order is A, B, D, E, and C, but by appropriately setting a weight according to the priority degree of each element, the priority order may be such as D, B, A, C, and E, for example. Otherwise, apart or all of business functions may be adjusted to be exchanged in the order such as A, D, B, F, and C, for example.

In FIG. 39, the full scores of the weighted index value of the five elements; the intensification, the amelioration, the recency, the past records, and the evaluation are adjusted as “8, 15, 11, 9, and 10,” the scope of the full score is not limited to this example. For example, the full score may be adjusted to be a 0 point, such as “10, 0, 15, 20, and 10,” “10, 0, 0, 10, and 10,” and “0, 10, 0, 0, and 10.” By adopting this 0 point for an adjustment, the adaptive function-selecting unit 22 may adjust the adaptability by limiting the number of the combining objects among the weighted index value relating to the five elements. As a result, it becomes possible that an element be not actually used for the evaluation of the adaptability. Thus, if the full score of the weighted index value of, for example, the amelioration or the evaluation is “0,” the adaptability may be evaluated making the three elements of, for example, the recency, the intensification, and the past records as objects. In this case, if amelioration is added within ten months, for example, the amelioration itself is accepted, but it is possible that the amelioration be not counted for the evaluation of the adaptability.

In regard to the “weighted search,” if the full score of the weighted index value is adjusted according to the priority degree of the three search methods, the adaptability may be adjusted by adding the priority degree of the search. Moreover, if the full score is adjusted to be a 0 point, a certain search method may be controlled as not actually being used for the evaluation of the adaptability. Further, in regard to both of the “weighted adaptive condition” and the “weighted search,” if the full score of the weighted index score is adjusted according to the respective priority degree, the adaptability may be adjusted in more detail.

According to the present embodiment, since adjustments of a search and adaptability are made by using weights, the intention of the management division may be adjusted and reflected in detail in selecting business functions suited to clients'needs.

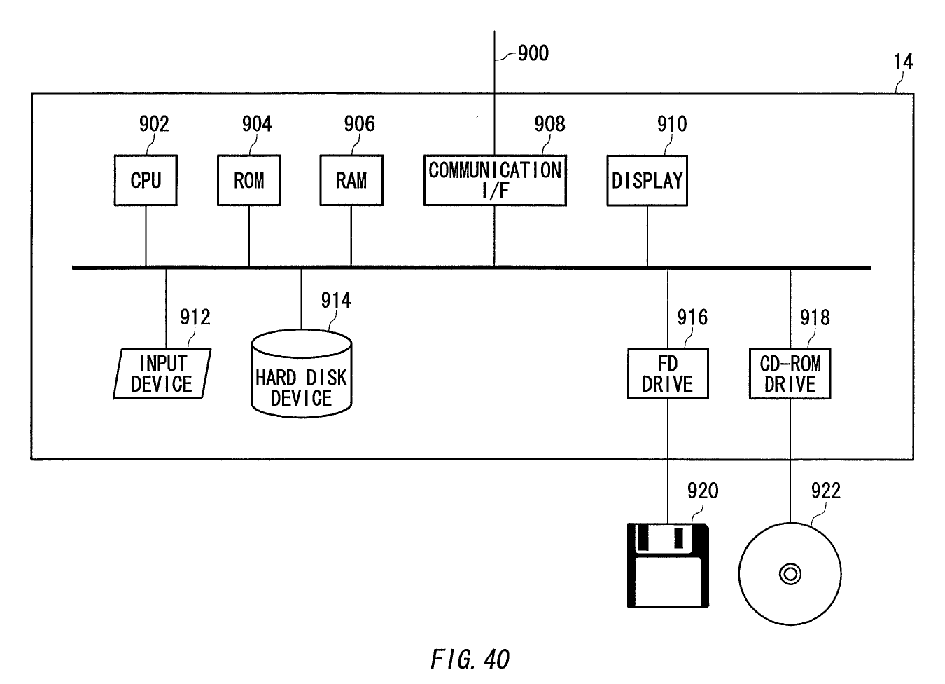

FIG. 40 illustrates an exemplary organization-supporting server 14 in the above-described embodiment consisted by using an electronic computer. The business-supporting server 14 according to the present embodiment includes a CPU (central processing unit) 902, a ROM (read only memory) disk 904, a RAM (random access memory) disk 906, a communication I/F (interface) 908, a display 910, an input device 912, a hard disk device 914, a FD (floppy disk) drive 9]6, and a CD-ROM (compact disk ROM) drive 918.

The business-supporting system 10 according to the present embodiment has the same basic structure and operations as each embodiment described above. For example, the program that instructs a computer to execute the processing procedures of the above-described embodiments is distributed with a recording medium such as a CD-ROM. The CD-ROM drive 918 reads data or the program from the CD-ROM 922 and transfers the read data or the program to the CPU 902. The hard disk device 914 stores the data or the program read by the FD drive 916 or the CD-ROM drive 918 or the data that the CPU 902 creates by executing the program, as well as reading the stored data or program and transferring the read data or program to the CPU 902.

The CPU 902 processes in the same way as the above-described embodiments based on the program stored in the ROM 904 and the RAM 906, which are examples of recording media. The communication I/F 908 mediates the transfers of communication data between the communication networks 900 such as the Internet. The display 910 displays input screens or the results of processing. A speaker may be arranged and may sound voice messages. Therefore,by reading the program from the CD-ROM 922 having the program for comprising each function unit of the business-supporting system described above, installing the program to the hard disk device 914, reading the program from the hard disk device 914, and executing the processing procedures described above, function described above may be achieved.

The program may be stored in the floppy disk 920 instead of the CD-ROM 922. Moreover, the system may set up an MO drive, and the MO drive may store the program. Further, the program may be stored in other recording media, such as a non-volatile semi-conductor memory card and the like. Furthermore, the system may obtain or update the program by downloading from other servers, for example, through the communication networks 900 such as the Internet.

The program, that is, software that is installed on the hard disk device 914, is provided with each function unit of such as a request-obtaining unit, an adaptive function-selecting unit, a function presentation-processing unit, and a business operation-processing unit as software, as the same as each organization-supporting system shown in the embodiments described above. The recording medium that stores this program is only used for making the business-supporting system. It is obvious that a making and a selling of such a recording medium as a business may constitute an infringement of a patent right based on the filing.

As described above, business functions of business-supporting organizations like general trading companies maybe offered appropriately to the client, according to the present invention.

Although the present invention has been described by way of exemplary embodiments, it should be understood that many changes and substitutions may be made by those skilled in the art without departing from the spirit and the scope of the present invention which is defined only by the appended claims.

What is claimed is:

1. A business-supporting system for supporting activities of a client, comprising:
a plurality of business functions;
a request-obtaining unit for obtaining key request information that represents a request of the client who is to be provided with a service from the system;
a business contents database having business contents information for each of said plurality of business functions; and
an adaptive function-selecting unit for selecting a business function, which is adapted to said request, from said plurality of business functions, by evaluating adaptability of said business contents information to said key request information based on said key request information and said business contents database.

2. The business-supporting system as claimed in claim 1, wherein said adaptive function-selecting unit evaluates said adaptability based on each of a plurality of elements of said key request information, which corresponds to the request of said client.

3. The business-supporting system as claimed in claim 1, wherein:
said key request information includes a question for eliciting said client's request, a keyword associated with said question, and character or text information input by said client; and
said adaptive function-selecting unit evaluates said adaptability based on at least two of: said business function previously corresponding to said question for eliciting said client's request respectively; said business function previously corresponding to said keyword associated with said question; and said business function retrieved based on said character or text information input by said client.

4. The business-supporting system as claimed in claim 3, wherein said adaptive function-selecting unit evaluates said adaptability by referring to each of: said business function corresponding to said question; said keyword corresponding to said question; and said business function retrieved based on said character information, with a predetermined degree.

5. The business-supporting system as claimed in claim 1, wherein:
said business contents information in said business contents database includes an aggregation of a plurality of business content elements; and
said adaptive function-selecting unit calculates said adaptability of said key request information to said business contents information based on the degree of the relevance of said key request information and said business content elements.

6. The business-supporting system as claimed in claim 5, wherein:
said business contents information includes a business contents sentence, in which business contents are described, and said business content elements are sentence elements of said business content sentence; and
said adaptive function-selecting unit searches a sentence element related to said key request information, from a group of said sentence elements that composes said business contents sentences for each of a plurality of said key request information, and calculates said adaptability of said key request information to said business contents information based on a result of said searching.

7. The business-supporting system as claimed in claim 1, wherein:
said business contents information includes a business record that corresponds to said business function; and
said adaptive function-selecting unit evaluates said adaptability of said key request information to said business contents information based on said business records.

8. The business-supporting system as claimed in claim 7, wherein:
said business contents information includes evaluation information, which indicates a magnitude of evaluation of said business records, together with said business records; and
said adaptive function-selecting unit evaluates said adaptability of said key request information to said business contents information according to said evaluation information of a related business record which is related to said key request information, when said related business record is included in said business contents information.

9. The business-supporting system as claimed in claims 7 or 8, further comprising a database-updating-processing unit for updating said business contents information of said business contents database according to a new business record, when said new business record is made.

10. The business-supporting system as claimed in any one of claims 1 to 4, wherein:
an adjustment-focused section based on a condition of said corresponding business function, is set in said business contents information; and
said adaptive function-selecting unit includes a conditional correspondence-adjusting unit for adjusting said adaptability based on the relevance between said key request information and said adjustment-focused section.

11. The business-supporting system as claimed in claim 10, wherein said adjustment-focused section is an intensification focus section of said business function.

12. The business-supporting system as claimed in claim 11, wherein the system limits the number of said business function that may be designated as said intensification focus section within a predetermined range.

13. The business-supporting system as claimed in claim 10, wherein said adjustment-focused section is an amelioration focus section of said business function.

14. The business-supporting system as claimed in claim 10, further comprising a database-updating-processing unit for updating said business contents database by setting said adjustment-focused section in said business contents information according to a request for setting said adjustment-focused section.

15. The business-supporting system as claimed in any one of claims 1 to 4, wherein said adaptive function-selecting unit adjusts said adaptability by using a predetermined weighted index value for adjusting said adaptability.

16. The business-supporting system as claimed in claim 15, wherein said adaptive function-selecting unit adjusts said adaptability by using a different weighted index value according to the time when said business function is designated as an intensification focus section.

17. The business-supporting system as claimed in claim 15, wherein said adaptive function-selecting unit adjusts said adaptability by using a different weighted index value according to the time when said business contents information of said business function is ameliorated.

18. The business-supporting system as claimed in claim 15, wherein said adaptive function-selecting unit adjusts said adaptability by using a different weighted index value according to the time when said business contents information is registered to said business contents database.

19. The business-supporting system as claimed in any one of claims 16 to 18, wherein said adaptive function-selecting unit sets said weighted index value higher when said time is newer.

20. The business-supporting system as claimed in claim 15, wherein said adaptive function-selecting unit adjusts said adaptability by using a different weighted index value according to the number of the past offer records of said business function.

21. The business-supporting system as claimed in claim 20, wherein said adaptive function-selecting unit sets said weighted index value higher when said number of said past offer records is larger.

22. The business-supporting system as claimed in claim 15, wherein said adaptive function-selecting unit adjusts said adaptability by using a different weighted index value according to the degree of recency of the past offer records of said business function.

23. The business-supporting system as claimed in claim 22, wherein said adaptive function-selecting unit sets said weighted index value higher when said past offer records is newer.

24. The business-supporting system as claimed in claim 15, wherein said adaptive function-selecting unit adjusts said adaptability by using a different weighted index value according to the degree of an evaluation on said business function adapted to said selected client's request.

25. The business-supporting system as claimed in claim 24, wherein said adaptive function-selecting unit sets said weighted index value higher when said evaluation is higher.

26. The business-supporting system as claimed in claim 15, wherein said adaptive function-selecting unit adjusts said adaptability by using a different weighted index value according to the degree of recency of an evaluation on said business function adapted to said selected client's request.

27. The business-supporting system as claimed in claim 26, wherein said adaptive function-selecting unit sets said weighted index value higher when said evaluation is newer.

28. The business-supporting system as claimed in claim 15, wherein said adaptive function-selecting unit adjusts said adaptability by limiting the number of combining objects among: a different weighted index value according to the time when said business function is designated as an intensification focus section; a different weighted index value according to the time when said business contents information of said business function is ameliorated; a different weighted index value according to the number of the past offer records of said business function; a different weighted index value according to the time when said business contents information is registered to said business contents database; and a different weighted index value according to the degree of an evaluation on said business function adapted to said selected client's request.

29. The business-supporting system as claimed in claim 15, wherein said adaptive function-selecting unit alters at a predetermined degree at least one of said weighted index values among: a different weighted index value according to the time when said business function is designated as an intensification focus section; a different weighted index value according to the time when said business contents information of said business function is ameliorated; a different weighted index value according to the number of the past offer records of said business function; a different weighted index value according to the time when said business contents information is registered to said business contents database; and a different weighted index value according to the degree of an evaluation on said business function adapted to said selected client's request.

30. The business-supporting system as claimed in claim 1, wherein:
said business contents information includes a new business contents section, which is intended to be newly prepared, in addition to an existing business contents section, which is already comprised in a corresponding business function; and
said adaptive function-selecting unit adjusts adaptability of said key request information to said business contents information depending on whether said key request information relates to said existing business contents section or to said new business contents section.

31. The business-supporting system as claimed in claim 30, further comprising a database-updating unit for updating said business contents database by setting said new business contents section in said business contents information by responding to a request for setting said new business contents section.

32. The business-supporting system as claimed in claim 1, further comprising an adaptive function candidate-selecting unit for finding an adaptive function candidate that is a candidate of said business function adapted to said key request information from among said plurality of business functions, before evaluating adaptability of said key request information to said business contents information, wherein said adaptive function-selecting unit evaluates said adaptability of said adaptive function candidate to said key request information.

33. The business-supporting system as claimed in claim 32, wherein said adaptive function candidate-selecting unit finds said adaptive function candidate from answers to a plurality of questions for retrieving a request of said client.

34. The business-supporting system as claimed in claim 1, further comprising a presentation-processing unit for presenting to said client said business function, which is to be provided to said client by said business function selected by said adaptive function-selecting unit.

35. The business-supporting system as claimed in claim 34, wherein said presentation-processing unit presents said plurality of business functions in a priority order, which is obtained from a degree of adaptability calculated by said adaptive function-selecting unit.

36. The business-supporting system as claimed in claim 34, further comprising a client perspective-obtaining unit for receiving information that indicates a point of interest of each of said client, wherein said presentation-processing unit changes presentation contents according to said client perspective information.

37. The business-supporting system as claimed in claim 36, wherein said client perspective-obtaining unit seeks said client perspective information on perspectives of said client, from answers for a plurality of questions for retrieving a request of said client.

38. The business-supporting system as claimed in claim 37, further comprising a perspective judgment criterion-storing unit for storing perspective judgment criterion information, which indicates said plurality of questions, a perspective of said client, and strength of interests towards said perspective, wherein said perspective-obtaining unit seeks said client perspective information according to said perspective judging criterion information.

39. The business-supporting system as claimed in claim 36, wherein said presentation-processing unit selects said presentation contents, which are to be presented to said client, from a plurality of said presentation content candidates that are prepared for an adaptive business function selected by said adaptive function-selecting unit based on said client perspective information.

40. A business-supporting method for supporting activities of a client, comprising:
obtaining key request information, which represents a request of a client; and
selecting a business function, which is adapted to a request of said client, by evaluating adaptability of business contents information to said key request information, based on said key request information and a business contents database, using said business contents database that has said business contents information for each of said plurality of business functions.

41. A program of a processing to support activities of a client, which is executed by a computer, the program comprising:
an obtaining module for obtaining key request information that represents a request of a client who gets a business offer from a business-supporting server of a business supporter; and
a selecting module for selecting said business function adapted to said client' s request using a business contents database having respective business contents information of said plurality of business functions, by evaluating adaptability of business contents information to said key request information based on said key request information and said business contents database.

42. A recording medium that stores a program, which can be read out and executed by a computer, and said program supporting activities of a client, comprising:
a key request information executing module for executing key request information which represents a request of a client who is provided with a service of a business-supporting system; and
a selecting module for selecting a business function, which is adapted to a request of said client, by evaluating adaptability of business contents information to said key request information, based on said key request information and a business contents database, using said business contents database that has said business contents information for each of said plurality of business functions.

43. A business-supporting system connecting to a client terminal for providing a client at the client terminal with a business support in association with at least one of a plurality of different business functions, the system comprising:
a client's request obtaining section connecting to the client terminal and receiving a request from the client terminal;
a business contents database storing business contents information for each of said plurality of business functions; and
an adaptive function-selecting section connecting both to said client's request obtaining section and to said business contents database, said selecting section receiving said business contents information from said business contents database and acquiring a key request information representing the request received from the client terminal for an evaluation of adaptability of said business contents information to said key request information.
